(19) United States
(12) Patent Application Publication
(10) Pub. No.: US 2008/0027847 A1
(43) Pub. Date: Jan. 31, 2008

(54) Self-hedging multi-layered investment system and method using internal contractual relationships

(76) Inventor: Samuel Masucci, Morristown, NJ (US)

Correspondence Address: MCDERMOTT WILL & EMERY LLP, 28 STATE STREET, BOSTON, MA, 02109-1775, US

(21) Appl. No.: 11/708,379

(22) Filed: Feb. 20, 2007

Related U.S. Application Data
(63) Continuation of application No. 11/455,568, filed on Jun. 19, 2006.
(63) Continuation-in-part of application No. 10/087,339, filed on Mar. 1, 2002.
Application No. 10/087,339 is a continuation-in-part of application No. 09/567,901, filed on May 10, 2000.
Application No. 09/567,901 is a continuation-in-part of application No. 09/408,103, filed on Sep. 29, 1999, now Pat. No. 6,513,020.
Application No. 09/408,103 is a continuation-in-part of application No. 08/961,121, filed on Oct. 30, 1997, now Pat. No. 5,987,435.
(60) Provisional application No. 60/691,397, filed on Jun. 17, 2005.

(51) Int. Cl. G06Q 40/00

(52) U.S. Cl. 705/36 R

(57) ABSTRACT

Proxy assets providing risk management capabilities are described, such as liquid interests in illiquid assets and economic indicators, without the deficiencies associated with other types of financial instruments. A proxy assets set is defined to respond to one or more indices. Each proxy asset may have a share value and a number of shares. The proxy assets can have a proxy assets set account value equal to a sum over all proxy assets of the products of the share value and the number of shares. At least one proxy asset account value per share is a function of an index. Two or more trusts including an Up-Holding trust and a Down-holding trust may hold various of the proxy assets.

### RELATED APPLICATIONS

This application is a Continuation of U.S. patent application Ser. No. 11/455,568 filed Jun. 19, 2006, which application is based upon and claims priority from U.S. Provisional Patent Application Ser. No. 60/691,397, entitled SELF-HEDGING MULTI-LAYERED INVESTMENT SYSTEM AND METHOD USING INTERNAL CONTRACTUAL RELATIONSHIPS, filed on Jun. 17, 2005 and assigned to the present assignee, and is a continuation-in-part of pending U.S. application Ser. No. 10/087,339, entitled PROXY ASSET SYSTEM AND METHOD filed Jun. 17, 2005 and assigned to the present assignee, which in turn is a continuation-in-part of Ser. No. 09/567,901 entitled TECHNIQUES FOR INVESTING IN PROXY ASSETS filed May 5, 2000, and assigned to the present assignee, which is a continuation-in-part of U.S. patent application Ser. No. 09/408,103 entitled PROXY ASSET DATA PROCESSOR filed Sep. 29, 1999, which is a continuation of U.S. patent application Ser. No. 08/961,121 entitled PROXY ASSET DATA PROCESSOR filed Oct. 30, 1997, which issued as U.S. Pat. No. 5,987,435 on Nov. 16, 1999; all of which applications are incorporated herein in their entireties by reference.

### FIELD

The present disclosure generally relates to systems and methods for managing a novel Proxy Asset investment vehicle and the institutions necessary to implement the Proxy Assets. More particularly, the present disclosure provides the self-hedging multi-layered investment system and method using internal contractual relationships and capable of creating, distributing, managing, and maintaining a plurality of Proxy Assets, linked to account activity in accordance with pre-determined criteria, and also executing trade, issuance and redemption of such Proxy Assets.

### BACKGROUND

A Proxy. Asset is a new kind of security that is designed to make effectively tradable existing broad categories of illiquid assets or claims on income flows, assets or claims that are individually difficult or impossible to buy, hold, or sell directly. The Proxy Asset is designed to have a traded market price that reflects the true liquid-market value of the illiquid assets or claims.

For example, Proxy Assets can be created that allow people to make investments in local real estate in a given city, and allowing owners of local real estate to hedge their exposure to real estate risk in that city, and also to allow them to see in the Proxy Asset share price an indicator of real estate prices in the city. For another example, Proxy Assets can be created to allow people to invest in claims today on shares of the flow of national income over future years of some country, or to allow people to hedge their own income risk, and also to see a market price of such a claim as never before. Thus, as used herein, the term Proxy Asset pertains to illiquid assets and to claims on income sources, such as human labor or human capital. For still other examples of illiquid assets that may be the basis of Proxy Assets, for example, privately held or infrequently traded corporate stocks, infrequently traded bonds, ships and aircraft, rare coins, precious gemstones, masterpiece paintings, livestock, and thoroughbred horses. These assets, like real estate, are highly illiquid, and are difficult or impossible to hedge using traditional hedging mechanisms.

A Trustee or Proxy Asset Data Processor may be employed as part of a Proxy Asset Management System, and is designed for creating, distributing, managing, and maintaining the Proxy Assets. The trustee or new data processor makes possible this fundamentally new kind of asset by defining and managing the dividend flow of these assets, guaranteeing payment of the defined dividend by management of underlying cash-value accounts, and also facilitating trade, issuance and redemption of such Proxy Assets and thereby assuring certain adding-up constraints for market prices.

The Proxy Assets are configured to simplify their use, and understanding by investors; to parallel familiar existing assets in appearance and in terms of the kinds of contingencies and activities that the investors become involved with, and to offer the same feeling of financial soundness. The Proxy Asset Data Processor is designed to reinforce and confirm these impressions among investors, by facilitating the basic functions necessary for the Proxy Asset's essential equivalence with other assets.

Making otherwise illiquid assets liquid is extremely important. With illiquid markets, investors may be stuck with an inordinately risky exposure to some illiquid assets and at the same time unable to diversify their portfolio into other illiquid assets. For example, in the market for single family homes, people may be excessively exposed to single family home price risk in their own city, unable to hedge this risk by shorting their city, and unable to invest in single family homes in other cities.

Laws and regulations regarding securities trading are designed to make a clear distinction between securities and derivatives (such as futures and options), and between securities and short sales. Institutions that hold securities as part of their portfolios may be restricted by charter, pronouncement, or regulation from dealing freely in derivatives or from making short sales. These restrictions are designed to guarantee against certain abuses, such as taking excessively speculative positions. Individual investors, fearful of getting into an unexpectedly leveraged position or of being exposed to large or unlimited losses in certain circumstances, may have simple personal rules of thumb so that they will not buy unusual investment instruments. Our Proxy Assets are designed to resemble existing well-known types of securities, like ordinary stocks, so that these restrictions may have their intended effect.

That Proxy Assets resemble familiar securities may also have certain psychological benefits. First, people are somewhat afraid of investing in exotic derivatives because they have the feeling that the structure of the contract is too complicated and abstract, unlike the common law concept of property that has been fundamental to human society since prehistoric times. People tend to feel insecure about an investment whose payoff is determined by a complex contract or mathematical formula in contrast to a traded market price. Second, there are familiar institutions and practices associated with ownership of securities that are not duplicated with most derivatives. For example, the simple notion that an asset has both an enduring capital value and also generates an income at regular intervals and that one may have a rule of thumb allowing one to consume the income but not the capital value itself. Third, many derivatives can involve margin calls to which investors can react very negatively because they force investors to focus on their losses from individual portions of their portfolio, even when their overall portfolio is doing well.

Thus, for example, investors who hedge against losses in holdings of an asset by taking short positions in the futures markets can be very upset by the repeated margin calls that would be the consequence of such hedging should prices increase. They tend to feel upset by the margin calls even though their losses in the futures market are compensated since the value of the portfolio of other assets is increasing, since the former is made more psychologically salient by the need to take action. An individual who hedges risk by taking a position in a Proxy Asset whose price moves opposite that of the asset hedged will not be confronted by margin calls, can just forget about the portfolio, and thus may be psychologically in a frame of mind that better promotes hedging.

There have been over time, many different types of investment vehicles. Investment Trusts (REITs) which were designed by an act of the U.S. Congress in 1960 to allow large numbers of investors in real estate, are no more than tax-exempt portfolios of existing readily-made real estate investments. The real estate that REITs cover is limited to already readily investable classes, excluding for example owner-occupied homes. REITs are not flexible and thus cannot meet current hedging and investment needs.

There are a number of mortgage, reverse mortgage, or sale-of-remainder methods that individual homeowners can use to reduce risk to them due to price fluctuations in their home. Shared appreciation mortgages have a long (though limited) history. A variation on this is the housing limited partnership. Reverse mortgages are contracts in which a homeowner is able to obtain a lifetime annuity from the value of his or her home; these reverse mortgages may pass some of the price risk to the mortgage lender. Sale of remainder refers to a contract in which the homeowner may sell a share in the house to another party with a contract to remain living in the house.

Home equity insurance, discussed in Robert J. Shiller and Allan N. Weiss, “Home Equity Insurance,” National Bureau of Economic Research Working Paper 1994, forthcoming, Journal of Real Estate Finance and Economics, incorporated herein by reference, is an insurance contract on an individual home that pays out if the price index for the region should fall sufficiently.

In 1994, Barclays de Zoete Wedd (BZW) started Property Index Certificates (PICs). These are bonds, with maturities of two, three, four, and five years, whose principal at maturity is tied to a commercial real estate price index. BZW owns companies like Canary Wharf and Imry as a result of bad property loans, and has issued the PICs as a way to insulate itself from further moves in commercial real estate prices. In November 1996, BZW also created what are essentially UK commercial real estate index settled futures, although there is no clearing house and BZW is always one side of the contract. An industry-wide group led by AMP Asset Management (the fund management component of Australia Mutual Provident), has been scheduled to start true index-settled UK commercial real estate futures markets in 1997.

There have been for some time ordinary puts and calls that are settled on indices, such as the Standard and Poor's Index Options. There have been certain swap arrangements that investment banks make between themselves and counter parties. Banks may make many such swap arrangements in such a way that the swaps cancel out, and the bank itself is bearing no risk.

The Standard and Poor Depositary Receipts (SPDRs, or, commonly, “spiders”) were created at the American Stock Exchange in 1993. Each SPDR is like a security, which is traded on the stock exchange, and behind it is an underlying basket of assets, representing the stocks used to compute the Standard and Poor Composite stock price average. Redemption and issuance rules enforce market price correspondence with the market price of the underlying portfolio. The assets held are the actual stocks themselves. Still, the SPDRs are used to create an asset that is like a stock and to insure that the market price corresponds at all times to the value of the basket of stocks. The “superunits” and the “supershares” created at the AMEX somewhat earlier also shared this property.

Certain computerized trading systems, such as that used at the Iowa Experimental Markets at the University of Iowa have been used in the past. For example, in their presidential election trading system, a security is created for every presidential candidate, and it pays $1 if that person is elected president. Since only one person can be elected president, the trading system can automatically create new securities whenever buy orders for all presidential candidates come in with combined offer prices equal to $1.

See also, “A Goal-Directed Financial Asset Management System” invented by Robert R. Champion and Basil R. Twist Jr., awarded U.S. Pat. No. 5,126,936 on Jun. 30, 1992, and a System for the Operation of a Financial Account invented by Charles A. Atkins and Amelia Island, and awarded U.S. Pat. No. 4,953,085 on Aug. 28, 1990.

Accordingly, none of the prior art satisfies the objectives of the present disclosure, and none shows the basic features of the disclosure as described hereinbelow. More background information can be found in the following references, the contents of which are incorporated by reference. Karl E. Case, Robert J. Shiller, and Allan N. Weiss, “Index-Based Futures and Options Trading in Real Estate,” with Karl E. Case and Allan N. Weiss, Journal of Portfolio Management, Winter 1993. Robert J. Shiller, Macro Markets: Creating Institutions for Managing Society's Largest Economic Risks, Oxford University Press, Oxford England, (Clarendon Series) 1993. Robert J. Shiller and Allan N. Weiss, “Home Equity Insurance,” National Bureau of Economics Working Paper, 1994.

### SUMMARY

Aspects of the present disclosure are directed to systems and methods for creating, managing, offering or trading securitized claims on related positions. In accordance with an exemplary embodiments of the present disclosure, systems and methods for implementing a multi-layered, self-hedging investment system are provided for creating, managing, offering or trading securitized claims on related positions.

In an exemplary embodiments, a system includes computer program modules, for example, implementing a method including:

(A) establishing an up-holding trust that increases in value (e.g., meaning it is entitled to a portion or an increasingly greater portion of the assets of the other holding trust under the contract described in B) as a function of a positive move in at least one index, price or economic variable and establishing a down-holding trust that increases in value (e.g., meaning it is entitled to a portion or an increasingly greater portion of the assets of the other holding trust under the contract described in B) as a function of a negative move in the at least one index, price or economic variable.

(B) entering a first set of contracts between the up-holding trust and the down-holding trust that provide for a transfer or reallocation of assets on a specified settlement date or dates to reflect a positive or a negative move in the at least one index, price or economic variable;

(C) entering a second contract between the down-holding trust and the up-holding trust that provide for a periodic transfer between the trusts of earnings realized on each trust's assets based upon positive or negative moves in at least one index, price or economic variable; this contract is optional and may not be presented in each transaction;

(D) defining an up-tradable trust related to the up-holding trust, the up-tradable trust issuing up-tradable claims backed by substantially all or some portion of the securitized claims issued by the up-holding trust; and

(E) defining a down-tradable trust representing the down-holding trust, the down-tradable trust issuing down-tradable claims backed by substantially all or some portion of the securitized claims issued by the down-holding trust.

In further exemplary embodiments, a system including computer program modules, can implement a method including:

(A) establishing a plurality of up-trusts that increase in value as a function of a positive move in at least one index, price or economic variable;

(B) establishing a plurality of down-trusts that increases in value as a function of a negative move in the at least one index, price or economic variable;

(C) entering a set of contracts between one or more of the plurality of up-trusts and one or more of the plurality of down-trusts, the set of contracts effecting a shift in value between the up and down trusts in response to a change in at least one index, price or economic variable; and

(D) offering securitized claims, as investments, against one or more of the plurality of up-trusts and/or the plurality of down-trusts.

In any of the embodiments according the present disclosure, a system may include any number of processing devices, which may be networked over any of a variety of wired networks, wireless networks, or both, and which may include and access any of a variety of memories, databases or both. Such databases may include third party database systems providing current or historical information and data, e.g., market, stock, exchanges, currency or other financial or related information or data. Real-time data may be received and sent via communication links included with a system configured in accordance with the present disclosure. Any of the foregoing computers, links, networks, databases or memories may be those known in the art, or those subsequently developed, so long as they perform the processing, storage and communication capabilities needed to implement the present disclosure.

In any of the various embodiments, (1) claims can be offered publicly or privately or both; (2) the one or more indexes, price or economic variable can represent performance-based indicators, such as, for example, either alone or in combination, one or more of a composite index, price or economic variable, individual stock, a price of any commodity, a market or market segment, event, industry, treasuries, bonds, a fund, economic indicators, or other indicators of performance of a person, entity, market, company, industry, geographic or political region or entity; (3) the claims may take the form of, for example, shares, debt or certificates; and (4) the claims may represent proxy, real, personal, tangible, or intangible assets.

The systems and methods herein can also implement “earnings distribution agreements” and/or “futures contracts.” Under such agreements, interest on the underlying cash or assets held by the trusts may earn interest, dividends or receive types of capital appreciation. The allocation of these amounts earned between the up and down holding trusts is defined in the earnings distribution agreements, along with other relevant aspects of the interest swap. Such earnings distribution agreements can take any of a variety of forms, as will be appreciated by those skilled in the art. Also, claims may be issued and redeemed in pairs or individually.

For the purpose of clarifying certain aspects of the present disclosure, various examples are provided later herein, which are intended to be illustrative and not limiting.

### BRIEF DESCRIPTION OF THE DRAWINGS

FIG. 1A is a block diagram illustrating a system for creating, managing, offering or trading securitized claims on related positions in accordance with the disclosure;

FIG. 1B is a more detailed block diagram of an exemplary embodiment of the system of FIG. 1A;

FIG. 1C are examples of closed paths the data processor of the systems described in connection with FIGS. 1A and 1B may identify;

FIG. 2 is a relational block diagram depicting the Proxy Asset Account Manager;

FIG. 3 provides a functional block diagram of the computer hardware available to practice the disclosure;

FIG. 4 provides a logic flow diagram for the Proxy Asset Generator;

FIG. 5 provides a logic flow diagram for the Account Manager;

FIG. 6 provides a logic flow diagram for the Dividend Generator;

FIG. 7 is a logic flow chart depicting the Proxy Asset Order Processor;

FIG. 8 is a logic flow chart illustrating an embodiment of the Proxy Asset Trading, Issuance and Redemption System;

FIG. 9 is a relational block diagram depicting the Proxy Asset Bundle Manager;

FIG. 10 is a block diagram of one embodiment or a proxy asset system; and

FIG. 11 is a block diagram of a portion of an embodiment of a proxy asset system including a shift control mechanism.

It should be understood by one skilled in the art that the embodiments depicted in the drawings are illustrative and variations of those shown as well as other embodiments described herein may be envisioned and practiced within the scope of the disclosure.

### DETAILED DESCRIPTION

The following description refers to several possible embodiments of the present disclosure. It should be understood by one skilled in the art that variations of the embodiments described herein may be envisioned and practiced within the scope of the disclosure.

Aspects of the present disclosure are directed to systems and methods for creating, managing, offering or trading securitized claims on related positions. In accordance with an exemplary embodiments of the present disclosure, systems and methods for implementing a multi-layered, self-hedging investment system are provided for creating, managing, offering or trading securitized claims on related positions.

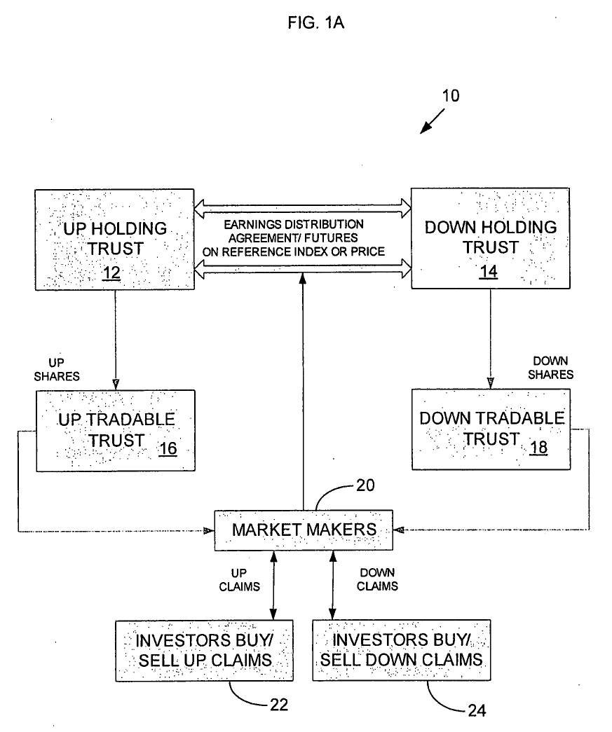

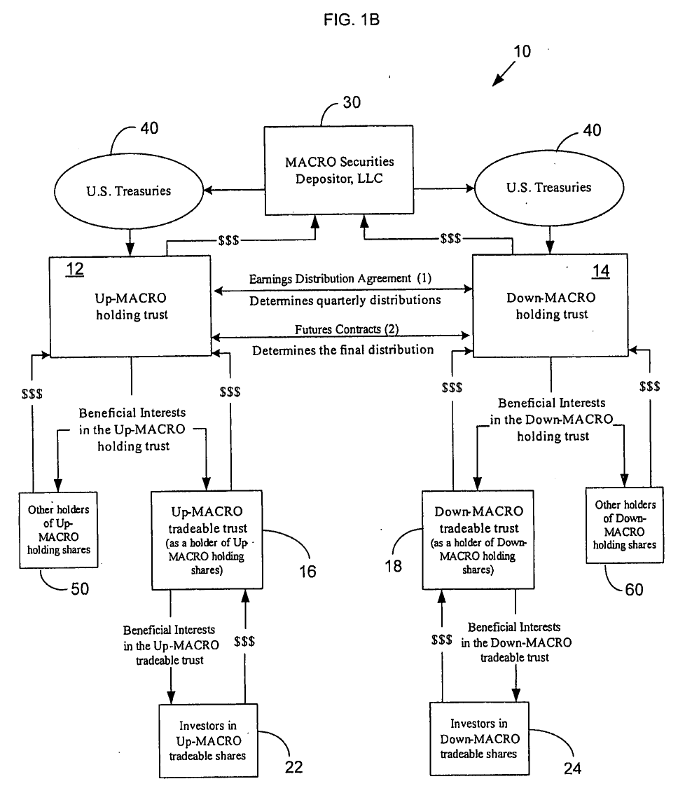

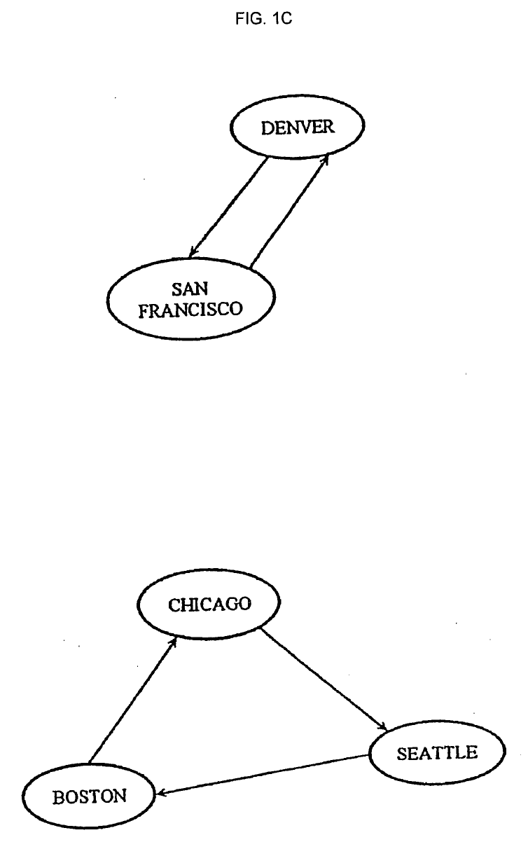

As used herein, the term “Claims,” can includes reference to claims, such as shares or “shares,” in a pair of trusts representing opposite positions in the value of a specified reference index, price or economic variable. Multiple layers of trusts may be formed. However, in the example shown in FIG. 1, two holding trusts are formed, the “Up Holding Trust” 12 and the “Down Holding Trust” 14 (each, a “Holding Trust”). The Up Holding Trust 12 will issue “Up Claims” in the form, in this case, of shares that will benefit from any increase in the value of the reference index, price or economic variable, and the Down Holding Trust 14 will issue the “Down Claims”, in the form of shares which will benefit from any decrease in the value of the reference index, price or economic variable (such certificates, the “Holding Trust Shares”).

General Structural Characteristics

The following represent various aspects of the present disclosure, which can be applied singly or in any combination to the various embodiments of the present disclosure:

Trustee: Holding trusts as described herein may be administered by a trustee, who can perform and manage the assets of the holding trust(s). A trustee typically manages the assets of the trust(s) and performs related calculations.

Two (Holding) Trust Structure: MACROs can be structured to include two separate trusts, e.g., an Up-MACRO holding trust and a Down-MACRO holding trust.

Depositor: Each holding trust can be formed by a suitable company, e.g., MACRO Securities Depositor, LLC, and affiliate of MACRO Securities Research, LLC.

Limited Life of Share: In exemplary embodiments, each holding trust can issue limited-life certificates or shares, which are outstanding for a predetermined term and which may be redeemed if a termination event occurs.

Principal Protection: Each holding trust can invest in desired instruments, e.g., highly rates short term financial instruments such as United States treasuries obligations. Exemplary embodiments can thus offer principal protection (giving effect to changes in a reference index) associated with the collateral deposited into a particular trust.

Underlying Value: The value of a holding trust can be determined by a formula, which can be subject to change/revision/modification. Such a formula can be applied to the assets of each holding trust to determine the underlying value of each holding trust. The “Underlying Value” of a holding trust on any determination date can, for example, equal all or a portion of the value of the assets in the Up-MACRO holding trust and a portion or none of the value of the assets in the Down-MACRO holding trust. The “principal amount” of the holding trusts, in exemplary embodiments, are not shifted during the life of the deal, but instead only the “interest amount” of the holding trusts are shifted and then distributed. The Underlying Value of a holding trust on any distribution date can represent the aggregate final distribution that would be made on the holding shares if those particular shares were redeemed on that distribution date, but no actual shifting of amounts need take place. The Underlying Value for each trust can be determined by calculating the amount of treasuries deposited in the trust and the value of the swap agreement and forward contracts based on the then current level of the referenced index on that date of determination.

Swap Agreement: In exemplary embodiments, each holding trust can enter into a swap agreement with the other holding trust, e.g., as a way/mechanism of allocating “available earnings” between the holding trusts. Available earnings can be an amount equal to the interest component on the treasuries minus fees and expenses of each trust. Available earnings can be calculated by each individual trust or trustee. In exemplary embodiments, after available earnings are calculated, the available earnings may be allocated between the holding trusts, e.g., based on the level of the swap agreement. Pursuant to the swap agreement, if the referenced index is above its starting level, then the Up-MACRO holding trust can pay a portion of its available earnings to the Down-MACRO holding trust.

Forward Contracts: Holding trusts described herein can enter into multiple forward contracts with one another as a way/mechanism of allocating the “asset amount” of each trust between the holding trusts. The “asset amount” can be essentially the principal amount in each trust. The asset amount of each holding trust may be calculated by an individual trust (possibly with hardware/software/firmware implementation of various embodiments of the present disclosure) or the trustee. Forward contracts can work in a similar fashion as the swap agreement, except that in exemplary embodiments, the shifting of assets between trusts occurs only upon the termination of the deal or the redemption of shares.

Subsequent Issuances: Additional shares of the Up-MACRO holding trust and Down-MACRO holding trust may be issued after the initial issuance of original shares. In exemplary embodiments, subsequent issuances can be performed in pairs an in proportionate amounts of Up-MACRO shares and Down-MACRO shares. Subsequent issuances may occur under certain circumstances and may be processed by the Trustee.

Redemptions: Up-MACRO holding shares and Down-MACRO holding shares may be redeemed. In exemplary embodiments, these redemptions may be performed in pairs and in proportionate amounts of Up-MACRO holding shares and Down-MACRO holding shares. Redemptions may occur under certain circumstances and may be processed by the Trustee

Two (Tradeable) Trust Structure: Each holding trust can issue limited life certificates that may, e.g., be held by a third party or deposited into two tradeable trusts, the Up-MACRO tradeable trust and the Down-MACRO tradeable trust. Such tradeable trusts may function to hold holding certificates and may be present for tax purposes in exemplary embodiments.

Types of Collateral/Investments: Each holding trust may hold different types of collateral or a system designed by a third party could hold a different type of collateral.

FIG. 1A is a block diagram depicting a system 10 for creating, managing, offering or trading securitized claims on related positions. As shown the system includes an Up Holding Trust 12 and the Down Holding Trust 14. As will be more evident, the Up Tradable Trust 16 is used to trade Proxy Assets for the Up Holding Trust 12, while the Down Tradable Trust 18 is used to trade Proxy Assets for the Down Holding Trust 12. Market Makers 20 provide assistance to Investors 22 and 24 with buy/sell Up and Down Claims.

The various elements of system 10 may be resident on or implemented with any of one or more computers, e.g., servers, which in turn may be connected to other computers or computer networks such as those including, but not limited to, the World Wide Web, the Internet, any suitable local area network (LAN), and/or any suitable wide area network (WAN). Further, the various functionalities of the systems and methods described herein may be implemented by any suitable hardware, firmware, and/or software (e.g., such as those useful for computer, telephony, and/or internet applications).

The Claims may have predetermined maturities, e.g., up to 99 years. Depending on the embodiment, an investor 22 or 24 in Claims may be entitled to receive: (i) periodic payments on a date (a “Distribution Date”) at the end of each quarterly, semi-annual or annual period running from (but not including) the current Distribution Date (or, in the case of the first Distribution Date, the initial issuance of the Claims) to (and including) the following Distribution Date, in the amount equal to the net amount (after payment of expenses) of earnings realized on the collateral held in the respective Up Holding Trust 12 or Down Holding Trust 14 during such period, adjusted pursuant to the Earnings Distribution Agreement (as defined below) to reflect changes of the Entitlement Amount (as defined below) of each Holding Trust based on the average change in value of the reference index, price or economic variable on each business day on which a calculation of the value of the reference index, price or economic variable is published (a “Calculation Date”) and (ii) at termination of the Holding Trusts, a pro rata share of the Entitlement Amount of such Holding Trust as adjusted pursuant to the Futures Contracts based on the change in value of the reference index, price or economic variable on the Calculation Day preceding the last Distribution Date. Such rights will be documented in the distribution provisions of the trust documents and such Earnings Distribution Agreement and Futures Contracts.

Initial Issuance of Claims to Investors

Claims can be sold in private placements to multiple private investors or in public offerings. In the case of either a public offering or private placements, two additional trusts may be but are not required to be formed, the “Up Tradable Trust” 16 and the “Down Tradable Trust” 18 (each, a “Tradable Trust”). The assets of the Up Tradable Trust 16 will be the Holding Trust Shares of the Up Holding Trust 12 and the assets of the Down Tradable Trust 18 will be the Holding Trust Shares of the Down Holding Trust 14. The Up Tradable Trust 16 will issue “Up-Claims” shares and the Down Tradable Trust 18 will issue “Down-Claim” shares (such certificates, the “Tradable Trust Certificates”), which will be entitled to pass through distributions of all amounts distributed on the Holding Trust Shares of the corresponding Holding Trust. Holding Trust Shares may be exchangeable for Tradable Trust Certificates and vice versa, on any Redemption Date, subject to satisfaction of the minimum lot requirements and any other applicable requirements for the particular investor involved.

Initially, Claims may be “priced” on the basis of a formula (the “Entitlement Formula”), established in certain future contracts (as described below), which reflects how changes in the value of the reference index, price or economic variable affect the amount of payments required to be made under such contracts from one Holding Trust to the other Holding Trust. For instance, the Entitlement Formula could entitle (in a transaction where the assets in each of the Holding Trusts equal, for example, $100) the Up Holding Trust 12 to receive $1 from the Down Holding Trust 14 for each 1 point increase in the value of the reference index, price or economic variable and the Down Holding Trust 14 to receive $1 from the Up Holding Trust for each 1 point decrease in the value of the reference index, price or economic variable, in each case at the time of redemption of the Holding Shares.

The Futures Contracts

In various embodiments contemplated, each Holding Trust 12 and 14 can enter into one or more futures contracts with the other Holding Trust in specified minimum notional dollar denominations which would be settled solely in cash at the termination of such contracts. The futures contracts can obligate the Up Holding Trust 12 to make a settlement payment to the Down Holding Trust 14 at termination in the event of a decrease in the value of the reference index, price or economic variable over the term of the futures contracts or on the last Calculation Date prior to their termination, and the Down Holding Trust to make a settlement to the Up Holding Trust 12 at termination in the event of an increase in the value of the reference index, price or economic variable over the term of the futures contracts. Funds raised from the initial sale and any subsequent sale of Claims (as discussed below), net of up-front fees and expenses, can be used to purchase treasury obligations or other highly rated assets maturing on or before the next Distribution Date. Each Holding Trust can secure its obligations under the futures contracts by granting to the other Holding Trust a security interest in the securities account holding the treasuries obligations or other highly valued assets. Upon the creation of additional Claims from the same Holding Trusts, the Holding Trusts can enter into additional futures contracts.

At termination of the futures contracts, settlement between the Holding Trusts will be funded with the proceeds of the maturing treasury obligations or other highly rated assets or delivery of the treasuries or other assets held by the Holding Trusts.

Periodic Adjustments of the Entitlement Amount

On each Calculation Date, the “underlying value” of the Holding Trusts 12 and 14 may be adjusted to reflect the effect of the change of the value of the reference index, price or economic variable on the underlying value of each Holding Trust to its own collateral and to the collateral held by the other Holding Trust (the “Entitlement Amount”) as a result of such Holding Trust's rights under the futures contracts written by the other Holding Trust, such that the Entitlement Amount of the Up Holding Trust 12 will increase as a result of an increase in the value of the reference index, price or economic variable and decrease as a result of a decrease in the value of the reference index, price or economic variable and the Entitlement Amount of the Down Holding Trust 14 will increase as a result of a decrease and decrease as a result of an increase in the value of the reference index, price or economic variable. The rate of adjustment of the Entitlement Amount between the Holding Trusts will be defined at the inception of the Holding Trusts by the Entitlement Formula. In this example, no transfer of collateral will occur until the futures contracts are settled or the Final Redemption Date (as defined below) or any earlier Redemption Date, but the adjusted Entitlement Amount will be used for calculation of the periodic interest payments (the “Periodic Earnings Entitlement”).

Earnings Distribution Agreement and Periodic Distributions of Earnings

Each Holding Trust may enter into an earnings distribution agreement (the “Earnings Distribution Agreement”) with the other Holding Trust the net effect of which will be that each Trust will have an amount equal to its applicable Periodic Earnings Entitlement available for distribution to its holders. Each Earnings Distribution Agreement will provide for a payment by one Holding Trust to the other on each Distribution Date.

The Up Holding Trust 12 may distribute the net amount of earnings received on its treasury obligations or other highly rated assets, plus any payment it receives pursuant to the Earnings Distribution Agreement or minus any payment it makes under the Earnings Distribution Agreement, after the deduction of fees and expenses, pro rata to the holders of the Holding Trust Shares including the Up Tradeable Trust 16, and any such distributions paid to the Up Tradable Trust 16 will be paid pro rata to the holders of the Tradable Trust Shares of the Up Tradable Trust 16, in each case outstanding on a Distribution Date. The Down Holding Trust 14 will distribute the amount of earnings received on its treasury obligations or other highly rated assets, plus any distribution it receives pursuant to the Earnings Distribution Agreement or minus any payment it makes under its Earnings Distribution Agreement, after the deduction of fees and expenses, pro rata to the holders of the Holding Trust Shares, including the Down Holding Trust 18, and any such payments paid to the Down Tradable Trust 18 will be distributed pro rata to the holders of the Tradable Trust Certificates of the Down Tradable Trust 18, in each case outstanding on a Distribution Date.

Subsequent Issuance of Claims to New Investors

Additional Claims can be created within any time period, e.g., on each business day. Such newly created Claims must be created in pairs of Up Claims and Down Claims shares, based on a specified ratio of Up Claims to Down Claims constituting a “Unit.” The price of the pair of Claims issued on any Calculation Date other than a Distribution Date will be increased by the amount equal to their pro rata share (after giving effect to the subsequent issuance) of earnings that would have been received by the Holding Trusts from the last Distribution Date through such date of subsequent issuance (the “Pre-Paid Accrued Earnings”). The Pre-Paid Accrued Earnings will be included in the Periodic Earnings Entitlement on the next Distribution Date, and investors in the additional Claims will be entitled to a pro rata share of the Periodic Earnings Entitlement (for the entire period) of the applicable Holding Trust.

Redemptions

The Claims may be redeemable on each Redemption Date in pairs of Up Claims and Down Claims constituting “Units.” Any investor interested in redeeming its Claims prior to the termination date of the Holding Trusts 12 and 14 may be required to purchase a number of Claims in the opposite position in the amount necessary to form one or more Units and present the “paired” Claims for redemption.

On the specified termination date for the futures contracts (the “Final Redemption Date”), each Holding Trust 12 and 14 can use the maturing treasury obligations or other highly rated assets to settle amounts due from one Holding Trust to the other Holding Trust pursuant to the futures contracts and the Earnings Distribution Agreement and distribute the remaining cash, together with any cash payment received from the other Holding Trust pursuant to the futures contracts and the Earnings Distribution Agreement, after the deduction of fees and expenses, pro rata to the holders of its Holding Trust Shares and any such distributions passed through to the corresponding Tradable Trust 16 and 18, and any other holder of Holding Shares will be paid pro rata to the holders of the Tradable Trust Shares of such Tradable Trust, outstanding on the Final Redemption Date.

Termination Triggers

In various embodiments, the occurrence of specified events, which are referred to as “termination triggers,” can cause an automatic termination of the earnings distribution agreement and the futures contracts and an early redemption of the paired holding shares and the Up-MACRO and Down-MACRO tradable shares (Proxy Assets). Upon obtaining knowledge or receiving notice of the occurrence of any of the following termination triggers, for example, the trustee can then give prompt notice of that event to each holder of paired holding shares of any of the following events:

the index, price or economic variable is not published a certain number of business days;

the index, price or economic variable rises above a certain dollars amount or falls below a certain dollars amount and remains above or below that level for a certain number of consecutive price determination days;

either of the paired holding trusts, the Up-MACRO tradable trust or the Down-MACRO tradable trust becomes an “investment company” required to register under the Investment Company Act of 1940, as amended; or

either of the paired holding trusts, the Up-MACRO tradable trust or the Down-MACRO tradable trust are adjudged to be bankrupt or insolvent or become involved in voluntary or involuntary insolvency or similar proceedings that are not dismissed within 90 days.

On the next distribution date following the occurrence of a termination trigger, which can be referred to as an “early termination date,” the trustee can cause the paired holding trusts 16 and 18 to settle all futures contracts and then make a final distribution on all of their shares.

Other termination triggers may apply to this MACROs structure. FIG. 1B shows an embodiment of an exemplary multi-level trust structure. In this example, the offering of Claims is limited to institutional investors, but that is not essential. The reference index, price or economic variable used is the S&P 500, though any of a number of individual or composite index, price or economic variables could be used. The value of the reference index, price or economic variable at the inception of the transaction is set to 100; again this value is used for illustrative purposes here but could be different in other examples.

It is assumed that there is equal demand for the Up-Claim and the Down-Claim position in this index, price or economic variable and an Entitlement Formula that is $1 for each change of one point (or one percent) in the S&P 500. The Distribution Dates occur quarterly, and the transaction terminates when the futures contracts mature on the second Distribution Date. Periodic dates when earnings are allocated and distributed are “Distribution Dates.” Any Distribution Dates may also be Redemption Dates.

With reference to FIG. 1, the following example is presented in the form of a timeline and involves one additional issuance on Day 4, a partial redemption at the option of a holder at the end of the first quarter, and the Final Redemption Date being the second Redemption Date. All of the foregoing assumption have been arbitrarily chosen and are not essential.

### EXAMPLE I

Day 1: An Up-Claim Holding Trust and a Down-Claim Holding Trust can be formed. The Up Holding Trust enters into a futures contract with a notional amount of $200 with the Down Holding Trust, which obligates it to pay to the Down Holding Trust at termination $1 for every point that the S&P 500 declines from 100, and obligates the Down Holding Trust to pay to the Up Holding Trust at termination $1 for every point that the S&P 500 increases from 100 (the “Up Futures Contract”).

The Up Holding Trust and the Down Holding Trust each issue $100 of Holding Trust Shares to institutional investors. The proceeds from the issuance of Holding Trust Shares of the Down Holding Trust are deposited in a securities account of the Down Holding Trust and pledged as collateral under the Futures Contract. The proceeds from the issuance of Holding Trust Shares of the Up Holding Trust are deposited in a securities account of the Up Holding Trust and pledged as collateral under the Futures Contract. Each Holding Trust uses the cash to purchase short-term treasury obligations or other highly rated assets which mature on the next Distribution Date. The principal amount of collateral held by each Holding Trust is initially $100.

In this case, upper and lower thresholds bind the upside and downside of the securities; this ensures that there is always enough assets between the trusts to cover the entitlement of the “winning” trust, while also generating earnings, to cover expenses related to administration of the securities. In this embodiment, the thresholds are set so that in event the S&P 500 index goes above 200 or to 0, the Futures Contract will be terminated and the related Claims redeemed.

Day 2: The value of the reference index, price or economic variable goes up to 102. The Entitlement Amount of the Up Holding Trust increases to $102 and the Entitlement Amount of the Down Holding Trust decreases to $98. No collateral is actually exchanged. By virtue of the Earnings Distribution Agreement, for Day 2, the Up Holding Trust will be entitled to earnings on $102, and the Down Holding Trust will be entitled to earnings on $98.

Day 3: The value of the reference index, price or economic variable decreases to 97. The Entitlement Amount of the Up Holding Trust decreases to 97 and the Entitlement Amount of the Down Holding Trust increases to 103. For Day 3, the Up Holding Trust will accrue interest on $97, and the Down Holding Trust will be entitled to earnings on $103 by virtue of the Earnings Distribution Agreement. The adjustment of the Entitlement Amount and interest accrued thereon continues in this manner on each Calculation Date.

Day 4: The value of the reference index, price or economic variable stays at 97. Additional Holding Trust Shares are issued, effectively doubling the amount of outstanding Holding Trust Shares. The price of the pairs of Holding Trust Shares to the purchasers of the Additional Securities is adjusted to include the Pre-Paid Accrued Earnings.

The Down Holding Trust enters into a new Futures Contract with a notional amount of $200 with the Up Holding Trust, which obligates it to pay to the Up Holding Trust at termination $1 for every point that the S&P 500 increases from 100 and obligates the Up Holding Trust to pay to the Down Holding Trust at termination $1 for every point that the S&P 500 decreases from 100. Each Holding Trust deposits the $100 that it receives from the additional issuance into its securities account as collateral under the Futures Contract. Each Holding Trust uses the cash received from the additional issuance to purchase short-term treasury obligations or other highly rated assets which mature on the next Distribution Date. The principal amount of collateral held by each Holding Trust is now $200. Each Holding Trust allocates the amount of Pre-Paid Accrued Earnings it receives upon the sale of the Claims towards the periodic earnings payment on the next Distribution Date.

End of Quarter 1: The value of the reference index, price or economic variable goes up to 110. Under the futures contracts, the Entitlement Amount of the Up Holding Trust is $220 and the Entitlement Amount of the Down Holding Trust is $180. The treasuries obligations or other highly rated assets purchased by or delivered to each Holding Trust on Day 1 and Day 4 mature. The actual amount of collateral held by the Up Holding Trust is $200 ($100 received on Day 1 plus the $100 received from the additional issuance of Holding Trust Shares on Day 4) and the amount of collateral held by the Down Holding Trust is $200 ($100 received on Day 1 plus the $100 received from the additional issuance of Holding Trust Shares on Day 4) excluding any earnings on the collateral in each trust.

Each Holding Trust makes payments under the Earnings Distribution Agreement such that each Holding Trust has cash in the amount of its applicable Periodic Earnings Entitlement plus any Prepaid Earnings and distributes such interest pro rata to the respective holders of its Holding Trust Shares after payment of fees and expenses.

A holder of 100 units of the Holding Trust Shares of the Down Holding Trust wishes to redeem such Holding Trust Shares. The holder purchases 100 units of the Holding Trust Shares of the Up Holding Trust in the secondary market at the applicable market price (ignoring any effect of the market perception on the direction of the reference index, price or economic variable this amount would be $110) though the actual market price may be higher or lower and submits the “paired shares” for redemption. One of the Futures Contracts with a notional amount of $200 settled early and $110 in cash is paid out from the Up Holding Trust and $90 is paid from the Down Holding Trust to such holder.

The remaining $100 of collateral in each Holding Trust is used to purchase treasury securities or other highly rated investment grade securities which mature on the next Distribution Date. The principal amount of collateral held by each Holding Trust is again $100. Due to the redemption and given the effect of the change in the value of the reference index, price or economic variable, the Entitlement Amount of the Up Holding Trust is reduced to $110 from $220 and the Entitlement Amount of the Down Holding Trust is reduced to $90 from $180.

End of Quarter 2: The value of the reference index, price or economic variable goes down to 75. The remaining futures contract is terminated and settled and the Holding Trust Shares are redeemed. The Treasuries or other assets purchased by each Holding Trust at the end of Quarter 1 mature. Under the Futures Contract the Up Holding Trust pays to the Down Holding Trust $25 in cash. The resulting $75 of the Up Holding Trust and $125 of the Down Holding Trust plus the Periodic Entitlement Amount, is distributed, after payment of certain fees and expenses, pro rata to the respective holders of the Holding Trust Shares.

### EXAMPLE II

With reference to FIG. 1B, an embodiment 10 shows a relationship is shown between an Up-MACRO® tradeable trust 16, an Up-MACRO holding trust 12, a Down-MACRO tradeable trust 18 and a Down-MACRO holding trust 14. Like the Up-MACRO holding shares, a portion of the Down-MACRO holding shares will be deposited into a Down-MACRO tradeable trust 18. However, in this embodiment 10, there is no contractual relationship between the Up-MACRO tradeable trust 16 and the Down-MACRO holding trust 14.

For the embodiment of FIG. 1B, under the Earnings Distribution agreement, the Up-MACRO holding trust 12 will either (a) be required to pay all or a portion of its available earnings to the Down-MACRO holding trust 14 or (b) be entitled to receive a portion of the Down-MACRO holding trust's available earnings from the Down-MACRO holding trust 14, based on fluctuations in the Fiserv CSW Los Angeles Home Price Index, price or economic variable.

The U.S. Treasuries 50, or obligations, constituting part or all of the res of each trust are shown. The other holders of Up-Macro holding shares 50 and other holders of Down-MACRO holding shares are also shown. Further, investors 22 and 24 in the Up-MACRO and Down-MACRO tradeable shares are also indicated.

Under each futures contract, the Up-MACRO holding trust 12 will either (a) be required to make a settlement payment out of the maturity proceeds of its treasuries to the Down-MACRO holding trust 14 or (b) be entitled to receive a settlement payment from the Down-MACRO holding trust 14 out of the maturity proceeds of the Down-MACRO holding trust's treasuries, based on the ending level of the Fiserv CSW Los Angeles Home Price Index, price or economic variable.

With reference to FIG. 1C, the drawing shows an illustration of the kinds of closed paths (complete sets) that the swap system processor identifies among the orders to buy and sell shares. The first set, set A, is just a San Francisco-Denver swap proxy asset paired with a Denver-San Francisco swap proxy asset. The second set, set B, is a complicated closed path involving three cities and three swap proxy assets.

The proxy asset data processor applies these more complicated definitions of complete sets and searches the data to find opportunities to issue, redeem, and allow trading of proxy assets, a process much more complicated than was the case with the up/down proxy assets. For example, setting the average account balance in the system (Vₜ/Sₜ) at $105.50 dollars per share, suppose that three book windows on the trading display screen are as shown by the following:

| | | | |
|---|---|---|---|
| Bid | Quantity | Offer | Quantity |

Boston Chicago Base 19980101

| | | | |
|---|---|---|---|
| 11015 | 100 | 12015 | 50 |
| 11014 | 50 | 12016 | 50 |
| 11013 | 50 | 12018 | 100 |
| Mar. 02, 1999 10:53 | | | |

Chicago Seattle Base 19980101

| | | | |
|---|---|---|---|
| 8593 | 50 | 8594 | 50 |
| Mar. 02, 1999 10:53 | | | |

Seattle Boston Base 19980101

| | | | |
|---|---|---|---|
| 12042 | 50 | 12043 | 50 |
| | | 12045 | 50 |
| Mar. 02, 1999 10:53 | | 12046 | 100 |

The proxy asset system and processor would discover that a bid for 50 Boston-Chicago shares a $110.15 matches with the offer to sell 50 Boston-Chicago shares, and so this trade would automatically be executed. Thus the match shown on the hypothetical window above would not persist for more than an instant. To execute these orders, there is no need for issuance or redemption. The computer will also discover that there is a bid for Boston-Chicago for another 50 shares at $110.15, a bid for 50 Chicago-Seattle shares at $85.93, and a bid for 50 Seattle-Boston shares for $120.42. It will discover that the sum of these prices is $316.5, or three times the average cash amount value per share (3 V.sub.t/S.sub.t), and so it automatically fills these orders by issuing the new proxy assets and allocating the proceeds from the sale into the respective cash accounts in proportion to amounts already there. Once again, these orders would not persist on the book window for more than an instant.

Note that in interfacing with an electronic trading system, such as the Globex or other system, embodiments of the invention include some modifications in the electronic trading system. For one example, traders would benefit from an embodiment which maintains more than one book window on the screen at a time, because of the interaction of orders within complete sets. For another example, traders who have asked the trading system to alert them when the price has hit a specific level, also benefit from an embodiment which alerts them in case any combination of orders for other proxy assets within the same compete set would suggest an opportunity to obtain the specified price by issuance or redemption at the specified price. This embodiment to provide such an alert relies on the embodiments which search for complete sets among the orders.

These swap proxy assets will work very well for those investors who already hold both real estate and other investments, but whose real estate investment is largely accounted for by their own homes, which are too concentrated in each city. For example, a person who owns a $400,000 home in Los Angeles and is worried about possible poor performance of real estate in Los Angeles relative to New York can invest $100,000 in proxy asset shares like those just described above, that are short in Los Angeles and long in New York. This creates a situation in which the investor is effectively invested in the Los Angeles market only in the amount of $200,000, and is effectively invested in the New York market in the amount of $200,000. The investor will thereby diversify risks equally between the two cities. The person could also invest $40,000 in each of four swaps, a New-York-Los Angeles swap proxy asset, a Miami-Los Angeles swap proxy asset, a Chicago-Los-Angeles swap proxy asset and a Denver-Los Angeles swap proxy asset. The investor will thereby diversify from an exclusive Los Angeles real estate position to a real estate position that is equally diversified across five cities.

The swap proxy assets are optionally bundled together and sold only as a group (called here a proxy asset bundle). For example, if there is much demand among residents of each city to swap their city real estate index for an average of all other cities, thereby effecting a diversified investment, then the only assets that need be marketed are the bundles of swaps that respond positively to a single city. Under certain conditions, these proxy asset bundles will provide the underlying swaps to the public which then may be disassembled later if demand appears for the individual components of the bundles.

If there is much demand among investors to invest in how well each city's real estate index will perform relative to all of the others combined, the relevant assets are the proxy asset bundles of swap proxy assets of each city versus all of the others. In this case, complete sets with only two elements would not exist; complete sets would require representation of all cities. Such structures permit investors to go long in the chosen city while requiring no one to hedge any city. Such a structure could be of value if the demand for hedging is minimal.

### EXAMPLE III

### Multi-Asset Pooling Proxy Assets

A third form of proxy asset may be referred to as multi-asset pools. This arrangement has no down securities, only up securities; the up securities for a given index function also as down securities for the others together. Here, N proxy assets, each, corresponding to an index Iat, a=1, . . . , N, at time t, swaps the one index against the remaining N−1 indices. A complete set is one of each of the N proxy assets. The account function that defines the balance per share after transfer in cash account a at time t may be given by the following Equation 1:

$$Balance = \frac{{V}_{t}}{{S}_{t}} + {I}_{at} - {\sum }_{a \neq a} \frac{{I}_{at}}{( N - 1 )} , a = 1 , … N$$

For example, if N=2, then the assets are analogous to swaps between pairs of assets, as with the swap proxy assets described above. For another example, if N=5, there are five proxy assets, for example, one for the real estate of each of the five largest cities of the country. Note that this formula satisfies the adding-up constraint; the total value of all accounts after transfers still equals the total amount in all accounts before transfer (but, after payout, if any).

Another account formula defines the balance in the cash account a at time t with a nonlinear formula:

$${Balance}_{at} = \frac{{V}_{t}}{{S}_{t}} \frac{{Nw}_{a} {INDEX}_{at}}{{\sum }_{a = 1}^{N} {w}_{a} {INDEX}_{at}} , a = 1 , … N$$

where the weights wa, a=1, . . . N correspond to the relative amounts outstanding of the various assets. (For example, cities with more people in them would get more weight.) A complete set is again one of each of the N proxy assets. With such a formula, the individual proxy asset accounts would never hit zero. Note that this formula also satisfies the adding-up constraint; the total value of all accounts after transfers still equals the total amount in all accounts before transfer (but, after payout, if any). The amounts in the various accounts would always correspond to the values in the various indices. Thus, there will be less of a need to issue securities with a new base year as time goes on. This multi-asset pooling proxy asset security will tend to be less volatile than the one defined by the linear formula.

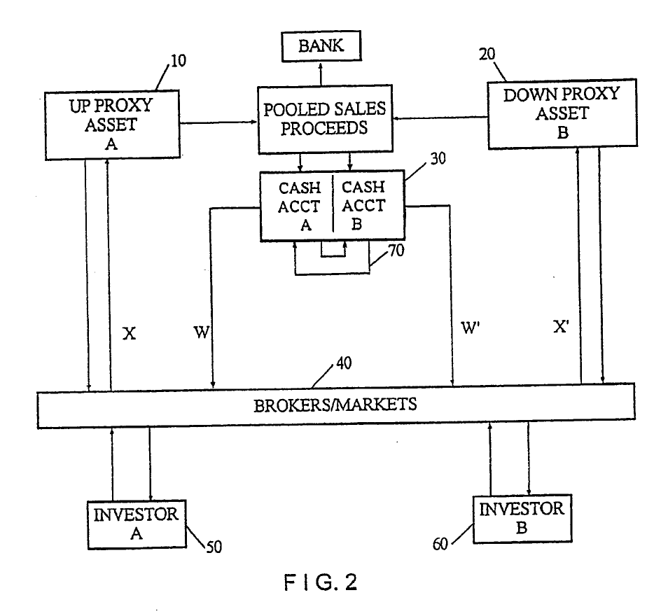

With the foregoing description in mind, attention is now directed to FIG. 2 providing a schematic block diagram of the proxy asset account manager in the up/down proxy asset version. In this exemplary arrangement, two proxy assets are created, and the two constitute a complete set.

In particular, the system proprietor issues shares of up proxy asset (A) (block 10), following orders placed in the system on behalf of investors by conventional brokerage arrangements (block 40). Similarly, the system proprietor also issues, at block 20, the down proxy assets (B), also following orders placed in the system by brokers on behalf of investors. Importantly, the shares must be issued only in complete sets, which in this example means that the number of A proxy assets issued must equal the number of B proxy assets issued. Receipts from the sale of both the up and the down securities are pooled by the system proprietor in the bank and then the individual cash accounts credited with shares of this pool, block 30, in proportions to the amounts per share already in these accounts.

As provided above, it can be recognized that no actual underlying illiquid asset has been identified or purchased by the system proprietor and, accordingly, no substantial transaction expenses have been incurred. The system operates to provide a proxy to real estate. The up proxy assets are marketed with a set of defining parameters including a link to an established index and the account, ACCT A, tied to these account balance would grow in proportion with the index. In a reciprocal manner, the down proxy asset's cash account balance would drop in value in proportion to an increase in the real estate index value. This is practically implemented by taking the actual capital from ACCT B and depositing it in ACCT A in correspondence with the changing index value, as shown at 70. ACCT A would grow and ACCT B would shrink by a like amount. As the underlying index is capable of both growth and retraction, FIG. 2 depicts capital flows in both directions.

In accordance with stored program logic, the system receives input on adjusted account balances and determines a dividend payment, W, corresponding to this new balance. An inverted relation is found between the index and the dividend stream of ACCT B, linked to the down securities. As real estate markets appreciate, funds in ACCT B are transferred out, leaving less capital for distribution generation W′, and thus a reduced distribution for the holders of the down proxy assets B even as the pooled resources grow in value. These proxy assets, however, should remain in demand at some price, because of the account value, and because of their usefulness as a hedging vehicle against a drop in real estate values.

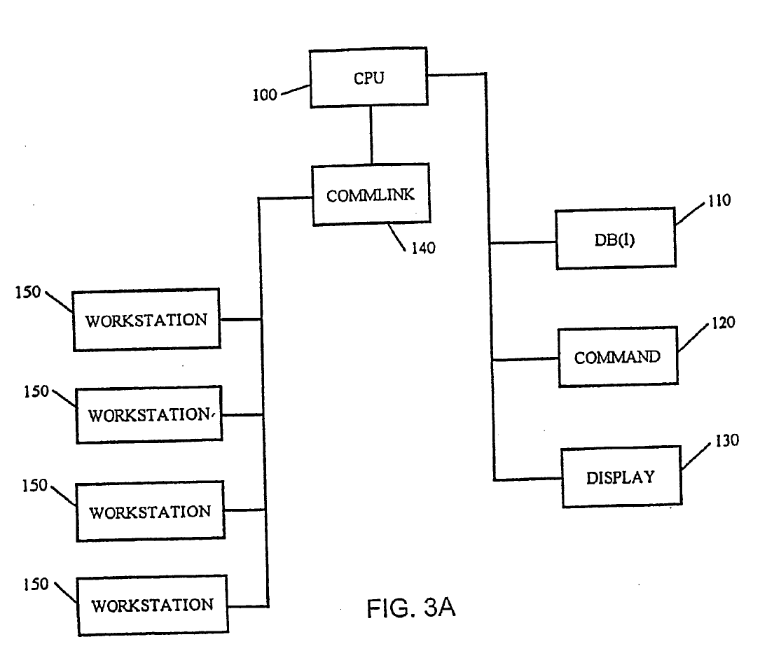

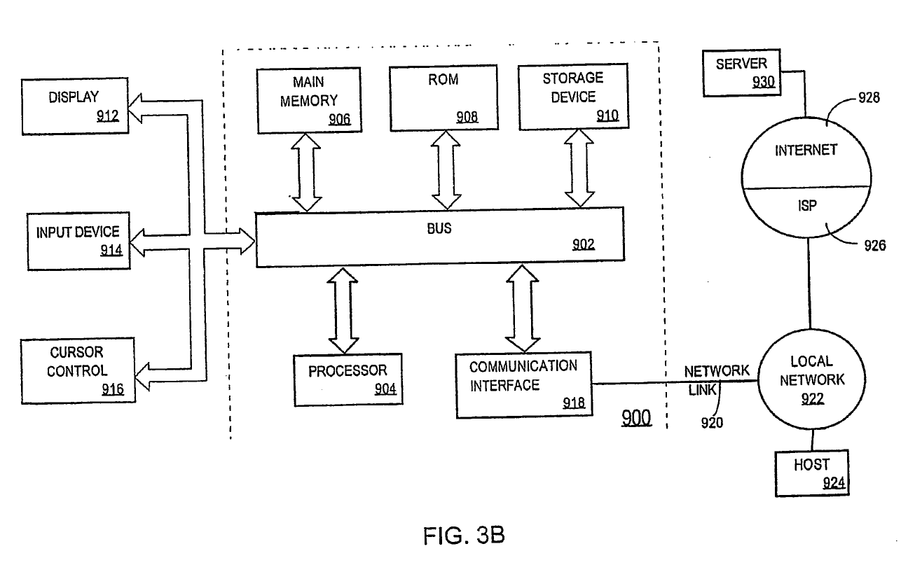

Implementation of the foregoing features is best accomplished via digital computer utilizing a uniquely defined controlling logic, wherein the computer system includes an integrated network between and among the various participants in the proxy asset security. This is depicted generally in FIG. 3A, wherein a block diagram highlights the components of a computer system useful for implementing these assets. The computer system is of conventional design, having a central processor (CPU) block 100 linked to a main database, DB(I), block 110. The main database includes archival data on the various securities, and allows proper manipulation of the underlying parameters in accordance with system logic. The database structure is outlined in detail in the database structure section below. The logic controlling system operation is stored in discrete memory block 120.

One aspect of the foregoing system involves the input of price or income indices and recording price movements and/or income changes necessary to implement changes in proxy asset accounts. Accordingly, the system includes commlink, block 140, to a network for proper controlled communication to various institutions and investors involved in the proxy asset. These participants have separate workstations, block 150, located at remote locations, but in communication with the system. It is expected that the bank, the index provider(s) and the brokers handling trades with individuals, as well as possibly the investing individuals themselves, will each communicate with the system proprietor.

The actual hardware configuration used is not particularly critical, as long as the processing power is adequate in terms of memory, accounts, periods of updating indexed values, the number of proxy assets and their respective cash account formulas and dividend payout formulas, and order execution, redemption and issuance. A network of PCs with a windows NT operating system is expected to give acceptable performance. Oracle based database engines allow substantial account coverage and expansion. The controlling logic uses a language and compiler to match that on the CPU 100. These selections will be set according to per se well known conventions in the software community.

Another embodiment of computer hardware on a network is shown in FIG. 3B. FIG. 3B is a block diagram that illustrates a computer system 900 upon which an embodiment of the invention may be implemented. Computer system 900 includes a bus 902 or other communication mechanism for communicating information, and a processor 904 coupled with bus 902 for processing information. Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 is coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

The invention is related to the use of computer system 900 for proxy assets. According to one embodiment of the invention, proxy assets are defined and managed by computer system 900 in response to processor 904 executing one or more sequences of one or more instructions contained in main memory 906. Such instructions may be read into main memory 906 from another computer-readable medium, such as storage device 910. Execution of the sequences of instructions contained in main memory 906 causes processor 904 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 904 for execution. Such a medium may take many forms, including but not limited to, non-volatile media, volatile media, and transmission media. Non-volatile media includes, for example, optical or magnetic disks, such as storage device 910. Volatile media includes dynamic memory, such as main memory 906. Transmission media includes coaxial cables, copper wire and fiber optics, including the wires that comprise bus 902. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 provides a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are exemplary forms of carrier waves transporting the information.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918. In accordance with the invention, one such downloaded application provides for values of pooled resources as described herein.

The received code may be executed by processor 904 as it is received, and/or stored in storage device 910, or other non-volatile storage for later execution. In this manner, computer system 900 may obtain application code in the form of a carrier wave.

An alternative configuration involves, instead of the 150 workstation linked by Windows NT, an Internet web site that allows trade directly over the Internet. Use of the system would still be restricted to brokers, if that is the objective, by suitable password procedures.

Table I appended herein shows an exemplary arrangement of the database for the proxy asset data processor. This table shows the records and fields that will be necessary for proper management under this embodiment.

There are three primary functions of the logic command instructions. The first is to allow controlled creation of proxy assets, by defining new proxy assets from scratch, by bundling existing proxy assets together, by debundling existing proxy asset bundles, or by combining some or all of the above. The second is to transfer balances among accounts so that the account formula is satisfied by the balances. The third is to define and allocate dividends on the proxy assets. In each case, the critical controlling data must be stored in the properly configured database.

The first of these three functions is important, as success in risk management requires identifying the appropriate risk categories; such categories may be changing all the time. For example, investor demand for proxy assets in real estate may suddenly shift to a small configuration of neighborhoods that might be represented by a combination of zip-code or census-tract real estate price indices. The system is designed to allow the creation of new proxy assets as automatically as possible by a trained representative of the system proprietor operating the proxy asset data processor or even possibly by broker clients themselves. If the cost of creating new proxy assets is made very low, then many more such proxy assets should be created.

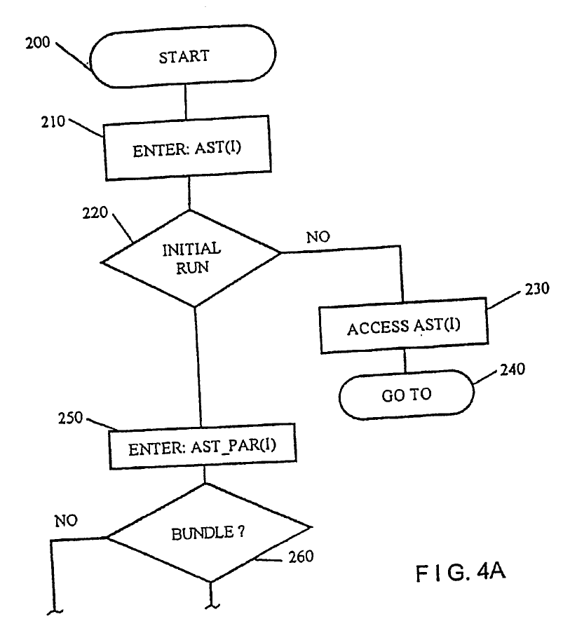

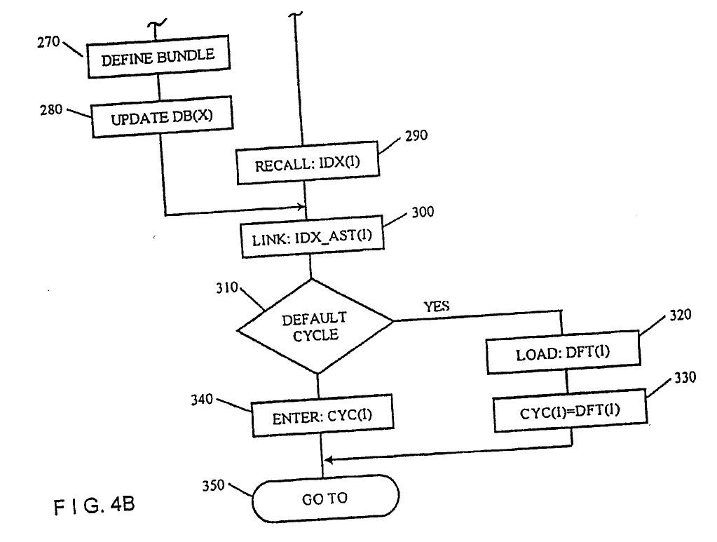

The first function is accomplished in accordance with the logic flow chart depicted in FIG. 4. Logic conceptually begins at start block 200 and continues to block 210 wherein the proxy asset under consideration AST(I) is entered by the system user. By AST(I) we mean, for the real estate example, a definition of the geographical area, identification of real estate price index, base year, cash account formula, and dividend payout formula. Since users will find it difficult to specify these, the system may provide tools, such as maps showing locations of zip codes or census tracts, and some summary statistics about the price indices for each of these.

The system first tests whether the entered proxy asset definition AST(I) is new and cannot be approximated by either existing proxy assets, an identical proxy asset already defined, by proxy assets with a slightly different base year, new bundles of existing proxy assets, components of existing proxy asset bundles, or by combinations thereof. In an initial run, test 220, the system searches over the existing proxy assets, the possibilities for new proxy asset bundles from existing proxy assets and components of existing proxy asset bundles to display the characteristics of the proxy assets that may be thus generated. The display includes information about the cash account balance that would be implied for the proxy asset under consideration. Possibly, some combination or division of proxy assets with a slightly different base year may be close enough to the proposed proxy asset. If the user signals that the entered proxy asset is not sufficiently new, if one of the possibilities put forward by the data processor is satisfactory, logic branches to block 230 and the existing records are pulled from the database for the already extant proxy asset or proxy asset bundles, with logic shifted to a separate subroutine.

A positive response to test 220 branches logic to block 250 wherein the parameters of the new proxy asset are entered into the system, and the parameters of the remaining elements of the complete set specified. In the case of simple up/down proxy assets, as illustrated in FIG. 2, the complete set can be automatically defined by the system, providing a definition of the proxy asset pair (AST_PAR(I)), both elements of which must now be created. At this point, it must be decided whether the new proxy asset pair should be defined in terms of a single index or whether the pair should be defined as a Proxy Asset Bundle in terms of a cluster of component indices. If the former, the system branches to block 290. If the latter, the system branches to block 270, where the bundle is defined, possibly by entering new indices into the system, and updating the database, block 280.

At test 310, the system queries about a default cycle for the asset adjustment period. A negative response to this allows custom entry of a controlling cycle, CYC(I), setting the time interval between adjustments for the accounts and dividends for the up/down proxy assets. The more common response to test 310 defaults the controlling interval to a system stored value, blocks 320-330. This completes the first portion of the processing with logic shifted to the next sequence, block 350.

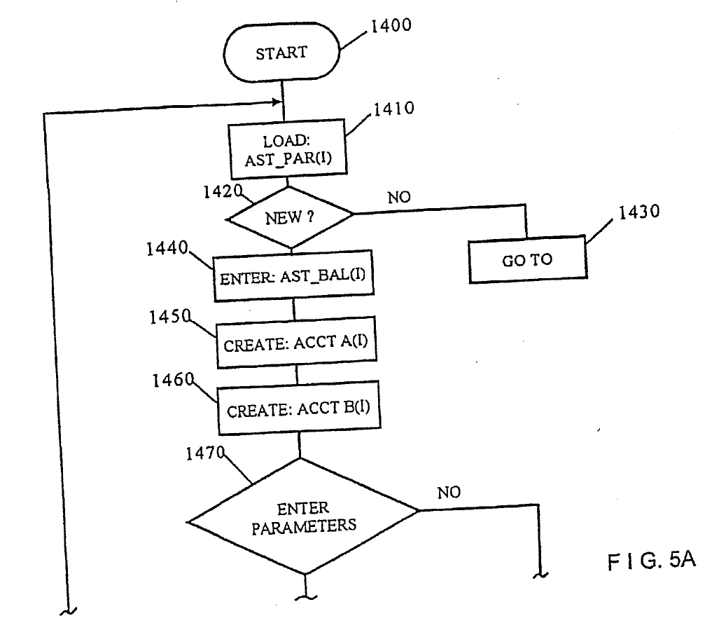

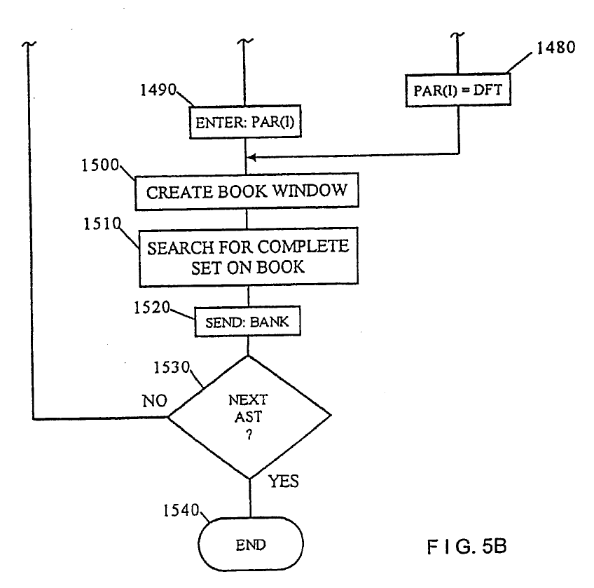

Creation of the underlying cash accounts and associated computer files and displays forming the foundation for the up/down proxy asset pair is accomplished by the logic control commands shown in FIG. 5. Beginning at start block 1400, logic first enables the entry of the pending proxy asset pair, AST_PAR(I) block 1410. The system checks whether this is a new proxy asset pair at test 1420. If new, logic continues to block 1440, wherein the cash account balance per share AST-BAL(I) is entered for both elements of the pair. These balances provide the financial backbone of the proxy assets. Implementation is made at blocks 1450-1460 setting up the two corresponding accounts ACCTA(I) and ACCTB(I): operation allows the entry of custom account parameters (“yes” to test 1470—and entry at block 1490) or entry of pre-selected default values, block 1480.

As previously described, the system includes a communication link between various participants and governing institutions. A book window is created, block 1500, for traders on the trading system, indicating, the initial defined cash account balances per share for both proxy assets in the pair, even though no shares yet exist. Orders may now be placed by customers that will appear on the book window. To create the first proxy asset share, since no shares yet exist, the trading system must first identify a complete set within the orders whose value equals (or exceeds) the combined cash account balances per share. Thereafter, the system can fill orders both by exchanging existing shares and by finding complete sets among orders. When a complete set is first created, the bank or similar repository of capital in account form must be notified with wire transfer of funds and automatic structuring of accounts particularized in advance in response to the order. During routine operation of the proxy asset system, the system proprietor will be directly responsible for rebalancing the accounts (maintained by the bank in pooled form only) within complete sets with the changing indices governing the accounts.

Returning to FIG. 5, after the database is updated with the current (and new) AST(I) information, logic queries on the next AST value (I+1) at test 1530; if another batch is ready, logic continues to the beginning and the process is repeated for the next in series.

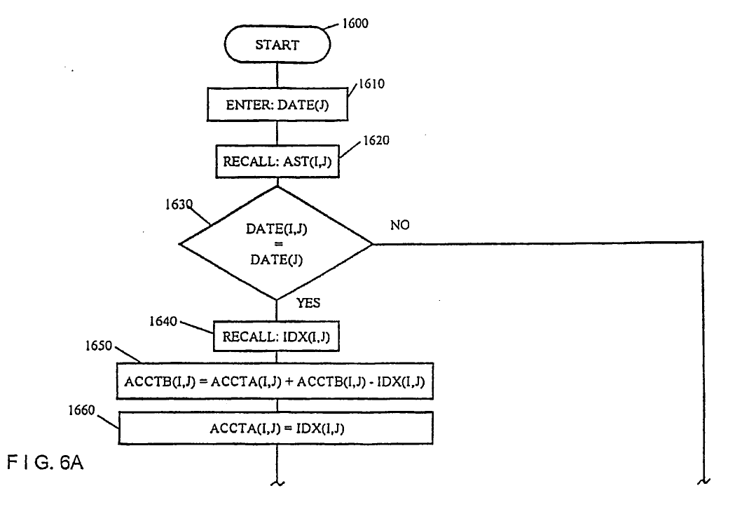

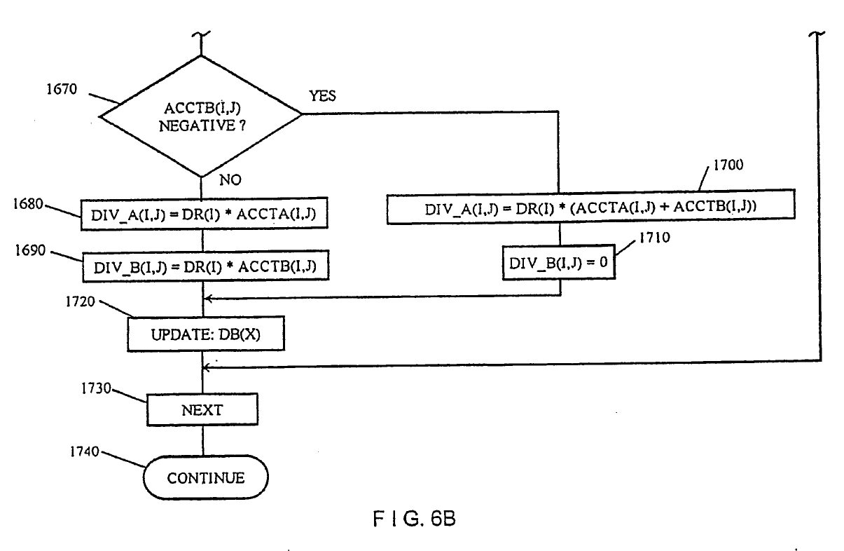

Day to day operation of the system requires analysis of a variety of time-varying inputs and selective calculation of a number of distinct variables to allow operation of the proxy asset. In FIG. 6, several of these operations and routine procedures are depicted as examples of system processing, recognizing that many other variables are tracked in like fashion.

Beginning with block 1600, logic in FIG. 6 first pulls the current date, date(J), and enters this into the process, block 1610. The current proxy asset pair file is recalled, block 1620 read, which includes the current asset balances updated for interest earned by the bank. The periodic date is compared to the present date to determine if the current date is an event date for adjusting the proxy asset accounts. A positive response to test 1630 reflects the match of dates and need to update the accounts. Accordingly, logic continues to block 1640 and the system recalls the current index value for the tracked asset, IDX(I,J). In this context, the counter variable J tracks the cycle—and thus absolute and relative time periods.

Continuing with FIG. 6, the system applies the cash account-formula to the down proxy asset, block 1650, making the balance per share equal the combined balances per share in the two accounts before the transfer minus the index, and applies the account formula to the up proxy asset, block 1660, making the balance per share just equal to the index. Note that the combined balances of the two accounts is unchanged by this transfer, so the transfer is always feasible, even though the down proxy asset cash account balance may be negative. Then the foregoing calculations are applied to calculate the appropriate dividend level per share for each proxy asset pair, using the distribution payout formula. In block 1670, the system queries whether the balance in the down proxy asset is negative. If not, the system proceeds to blocks 1680 and 1690, where each account is given a dividend at the rate DR(I). If so, then the system branches to block 1700, where the up proxy asset is defined a dividend equal to DR(I) times the combined values in the two accounts, and block 1710, where the down proxy asset is given a dividend of 0. These values are then stored in the main database, DB(x) at block 1720, and the entire process repeated for the next proxy asset under management by incrementing index variable I, block 1730.

As previously described, this embodiment of the system includes a communications link between various participants and governing institutions. These participants include a bank or similar repository of capital in account form, with wire transfer of funds and automatic structuring of accounts particularized in advance, and individual brokers or even individual investors who might place orders directly with the system. During routine operation of the proxy management system, the bank will be directly responsible for investing the pooled balances of the cash accounts, while the proxy asset system will be responsible for maintaining the cash accounts for the individual proxy assets, thereby in effect dividing up the balance in the bank among proxy asset shareholders.

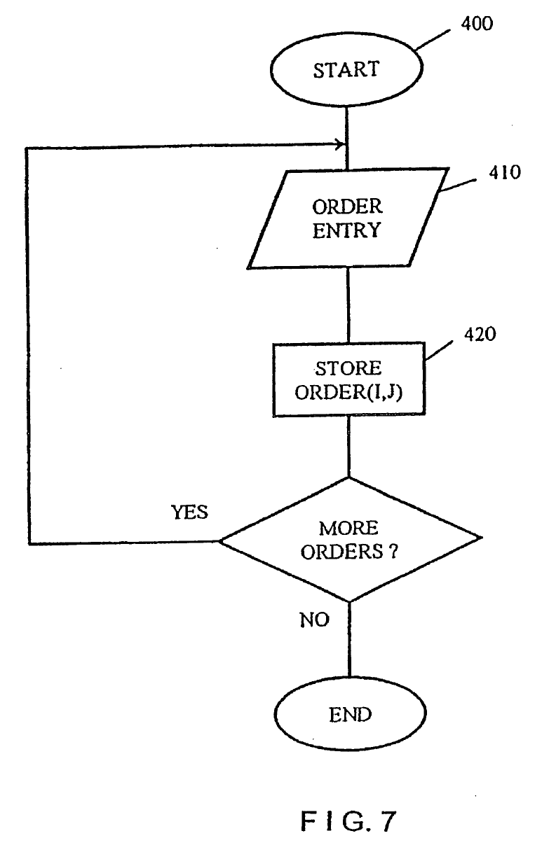

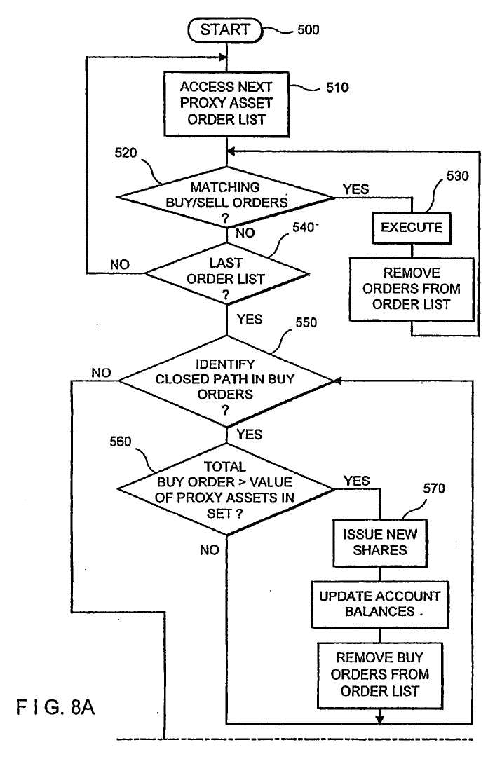

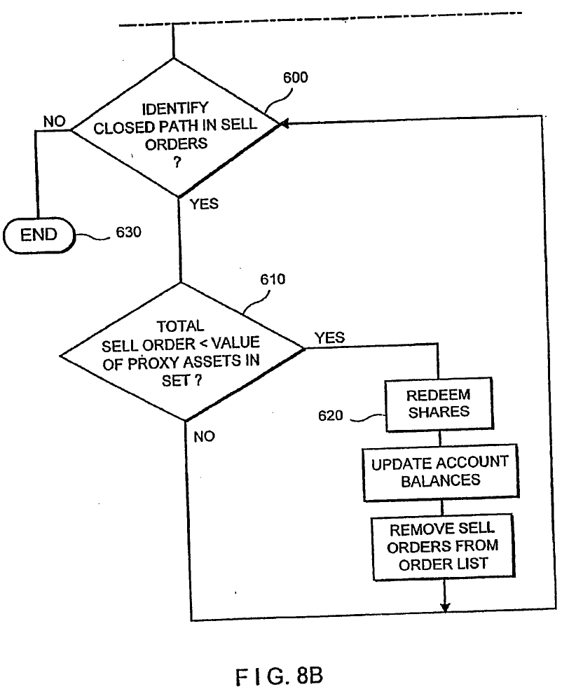

Execution of orders, by issuance and redemption or matching and clearing of buy and sell orders, for the proxy assets is accomplished by the logic and control commands detailed in FIGS. 7 and 8. FIG. 7 shows the proxy asset order processor. Beginning at start block 400 in FIG. 7, the order entry subroutine is detailed. Orders are received at block 410 from investors or brokers via workstations 150 (FIG. 3) or Internet link. Orders may consist of market orders (to buy or sell a specific number of a specific proxy asset at any price) or limit orders (to buy a specific number of proxy assets at or below a certain price or to sell a specific number of proxy assets at or above a certain price, bids and offers, hits and takes), or possibly other kinds of orders. These buy and sell orders are stored, at block 420, in a pending order list for each proxy asset in what is essentially equivalent to a book window in the trading system. In one embodiment, they are arranged in the book window with the highest bid at the top of one column and the highest offer at the top of another column, with prices in descending value below these.

With reference to FIG. 8, the proxy asset trading, issuance and redemption system begins at block 500. In a subroutine beginning at block 510, the pending order lists corresponding to each proxy asset are individually accessed and searched. At block 520, if a buy order for a proxy asset is matched with an identical sell order for that proxy asset, those shares are traded at block 530 without the issuance or redemption of any additional shares. Those orders are removed from the pending order list and processing returns to block 520 to search for additional matching orders. When no additional matches are present in the pending order list for the current proxy asset, the NO path from block 520 is followed and processing loops to the next asset in the system.

When all matching orders in the system have been processed, logic extends to block 550, whereupon the buy orders for all proxy assets in the system are together searched for a complete set or closed path. As discussed in Example I, a complete set is just an up/down pair. In Example II above, closed paths may consist of reciprocal swap proxy assets (e.g., ij and ji) or a more complicated set, such as an ij swap, a jk swap, and a ki swap (or any other path beginning and ending on the same asset). The combination of the proxy assets in the path have a total value as discussed in Example II. The sum of the buy orders in the path must equal or exceed this value. If so, test block 560 branches to a processing routine, beginning at block 570, for issuing new shares of these proxy assets, updating the accounts of the respective proxy assets in the proportion to amounts already there, then deletes these buy orders from the pending order list, before returning to loop 550 to search for additional closed paths. Alternately, if the sum of the buy orders in the identified path does not meet the total value of the path, the path identified in block 550 is rejected at test 560 and different path combinations are searched.

When no additional complete sets (closed paths) are located in subroutine 550, processing continues to a subroutine beginning at block 600, searching for closed paths of sell orders in the pending order lists of all proxy assets in the system. The sum of the sell orders is compared to the total value of the proxy assets in the identified path at block 610. If greater, the orders are executed beginning with block 620 by redeeming existing shares of these proxy assets, updating the accounts to reflect the redeemed proxy assets and deleting the sell orders from the pending order list. Processing then continues to exhaust all possible closed paths. When all closed paths are identified, the subroutine ends at block 630. Alternately, the subroutines of FIG. 8 may be performed in a different order, e.g., beginning at blocks 510, 550 or 600 as separate, and/or concurrent subroutines.

The execution of the buy and sell orders may also be connected to procedures whereby trade is suspended in unusual market situations, akin to the circuit breakers of organized exchanges. The execution of the buy and sell orders may be limited to certain classes of customers, such as registered broker dealers. The execution of the buy and sell orders may also be connected to a market surveillance system, like those at existing exchanges, to check for attempts at market manipulation or other illegal trading practices.

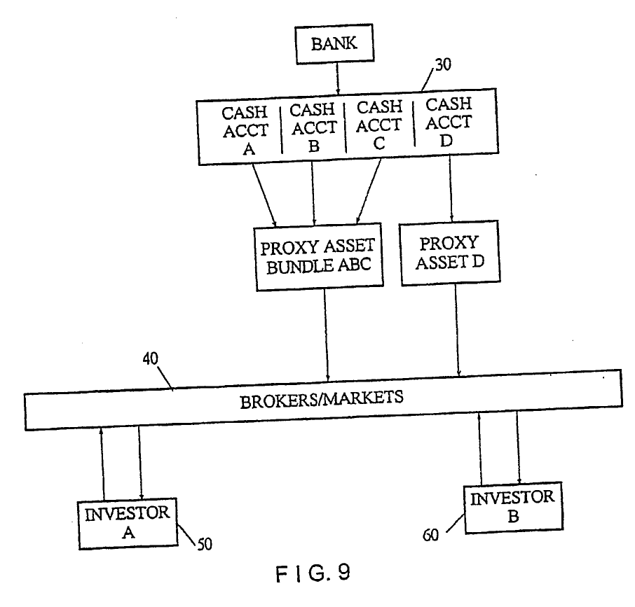

FIG. 9 is a relational block diagram depicting the proxy asset bundle manager. In this diagram, four proxy assets, proxy assets A, B, C, and D are shown for illustration. In this example, only proxy asset D is sold directly to the public. Proxy assets A, B, and C are bundled together as shown, and the bundle is sold to the public. Since the accounts for proxy assets A, B, and C are already in place, and their account formulas and distribution payout formulas already defined, people will have some idea of the effects of taking this proxy asset bundle apart at a later date. Knowing that the proxy asset bundle may be decomposed later may facilitate its marketing to the public today.

Table 2 appended herein shows an outline of the functions of the proxy asset data processor according to one embodiment. The table gives an outline of the basic steps that this data processor must handle, on a continuing or daily basis, and the steps that are undertaken only on a less frequent basis.

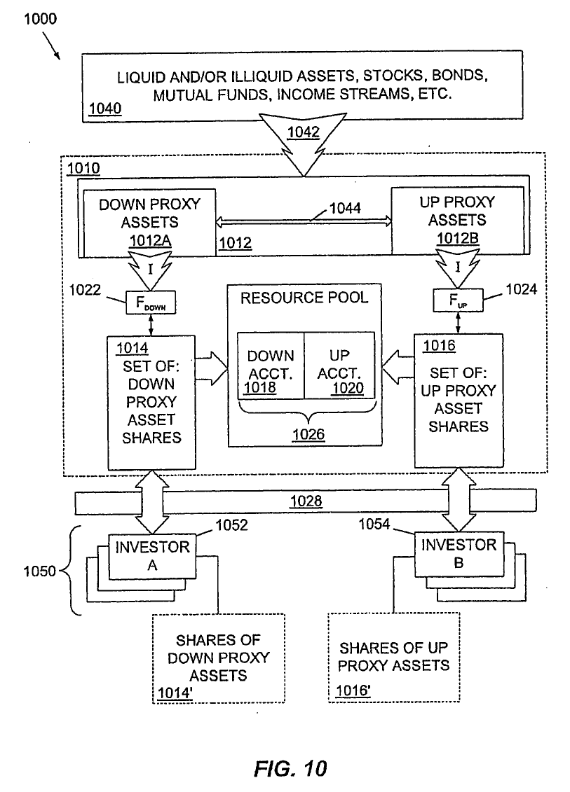

A proxy asset system in accordance with the present invention may take the form of proxy asset system 1000 of FIG. 10. In such an embodiment, a set of proxy assets 1012 is defined and related to one or more underlying assets 1040, which may include one or more of a variety of publicly or privately available liquid or illiquid assets, or some combination thereof. For example, and not by way of limitation, the underlying assets 1040 may include one or more of either publicly or privately available individual corporate stocks, groups of corporate stocks, mutual funds, and bonds, as well as streams of income (e.g., revenues or accounts receivable) from corporations, partnerships, joint ventures, sole proprietorships, individuals, trusts, estates, contracts, and so forth. The underlying assets may also include any other previously mentioned or implied types of assets. Furthermore, the underlying assets may include other proxy assets, or funds including proxy assets.

Underlying assets may be represented by one or more asset indices that are either commonly known, uniquely defined, or some combination thereof. In FIG. 10, such asset indices are represented by arrow 1042. As examples, a set of asset indices may include one or more domestic or foreign composite indices, such as an index representing S & P 500, NASDAQ, DJIA, NYSE Composite, Nikei, and so on. An asset index may also represent a single asset, such as an individual corporate stock or a mutual fund. Additionally, the set of proxy assets 1012 is represented by a proxy asset index, denoted as “I” in FIG. 10. The value of the proxy asset index is responsive to the asset indices 1042, and is a function thereof. The proxy asset index may completely mirror the asset indices or may be a weighted function of the asset indices. In some embodiments, the various asset indices that comprise the set of asset indices may be weighted differently, i.e., by one or more leverage factors. In any event, preferably, as the values of the asset indices 1042 change so too does the value of the proxy asset index.

The set of proxy assets 1012 includes at least two subsets of proxy assets, a set of down proxy assets 1012A and a set of up proxy assets 1012B. In other embodiments, the set of proxy assets 1012 may include more than two subsets of proxy assets and the assets need not be characterized as “down” and “up”, but preferably have some type of value-based relationship, wherein a change in the proxy asset index causes different changes in the values of different defined proxy asset shares related to the different subset of proxy assets. For example, in one embodiment two subsets of down assets and three subsets of up proxy assets may be defined. In other examples, 1 subset of low risk, 1 subset of moderate risk, and 1 subset of high risk proxy assets may be defined, and so on. In such cases, each subset may offer a different risk reward to the investor. In the embodiment of FIG. 10, these different types of risk rewards are embodied in the functions (e.g., functions F.sub.down 1022 and F.sub.up 1024 discussed below) that control the value of the corresponding proxy asset shares.

In FIG. 10, shares are offered to investors as claims on the set of proxy assets 1012. The shares may be offered publicly, privately, or some combination thereof. A set of down proxy asset shares 1014 is offered against the down proxy assets 1012A and a set of up proxy asset shares 1016 is offered against the up proxy assets 1012B. The market values of the down proxy asset shares 1014 and the up proxy asset shares 1016 are a function of the proxy asset index. Down shares and up shares may be purchased, sold, and/or valued in different manners and/or by different entities. Also, shares related to different sets of proxy assets (e.g., up shares and down shares) may be offered at the same time, or at different times. Shares for a given set of proxy assets (e.g., down shares 1014) may be issued and redeemed at different times (e.g., incrementally, periodically, etc.). Whether offered at the same time or offered at different times, generally, any proxy asset shares may be offered as a function of one or more conditions (e.g., the value of the resource pool reaching a certain threshold, the value of the proxy asset index reaching a certain threshold value, the value of the asset indices reaching a certain value, and so on).

A purchase of down proxy asset shares 1014 anticipates a fall in the proxy asset index, while a purchase of up proxy asset shares 1016 anticipates a rise in the proxy asset index. Therefore, as the value of the proxy asset index changes, so too does the value of the down proxy asset shares 1014 and the value of the up proxy asset shares 1016. A down account 1018 may be defined that represents the value of the down proxy asset shares 1014 and an up account 1020 may be defined that represents the value of the up proxy asset shares 1016. When the proxy asset index goes down, the value of down proxy asset shares is adjusted upwardly according to a down-function, e.g., function F.sub.down 1022, and the value of the up shares 1016 goes down correspondingly. When the proxy asset index goes up, the value up proxy asset shares is adjusted upwardly according to an up-function, e.g., function F.sub.up 1024, and the value of the down shares 1014 goes down correspondingly.

The transfer of value between down proxy asset shares 1014 and up proxy asset shares 1016 is implemented as a shifting of proxy assets back and forth between the two opposed positions, i.e., between the subsets of down proxy assets 1012A and up proxy assets 1012B. This shifting is represented by arrow 1044 and is a function of the proxy asset index (I), which is a function of the asset indices 1042. Therefore, as an example, in response to an increase in the asset indices, the proxy asset index will also increase. Consequently, if the value of the change in the proxy asset index correlates to “X” proxy assets, then X proxy assets will be shifted from the pool of down proxy assets 1012A to the pool of up proxy assets 1012B. Accordingly, the value of up proxy asset shares 1016 will increase and the value of down proxy asset shares 1014 will decrease, since the total number of issued down and up proxy asset shares is unchanged. Although, as will be discussed below, for rebalancing purposes the number of shares issued may be altered.

Investors (e.g., Investor A and Investor B) purchase down proxy asset shares 1014′ and/or up proxy asset shares 1016′ and the currency used to purchase those shares is combined and represented by a resource pool 1026. For all intents and purposes, the resource pool 1026 includes, and constrains, the down account 1018 and the up account 1020. That is, regardless of the changes in the values of the up proxy asset shares and the down proxy asset shares, the resource pool 1026 constrains the value of the down account 1018 and the value of the up account 1020 such that the investor can not lose more money that the investor invested.

The constraint provided by the resource pool 1026 is a function of the way in which the currency that comprises the pool is invested, i.e., the way in which the proxy assets are collateralized. While the set of proxy assets 1012 represents liquid or illiquid assets, the proxy assets 1012 are preferably collateralized, at least in part, by relatively stable (i.e., low risk, reliable rate of return) securities, such as U.S. Treasury securities. Since these types of securities do not tend to lose value and, in fact, have predictable, though conservative, rates of return, the resource pool 1026 itself is practically not at risk of being diminished, and in fact earns interest income. As an example, proxy asset shares, generally, may be configured to pay dividends as a function of the interest earned on the Treasury securities used to collateralize the set of proxy assets 1012. In other embodiments, the set of proxy assets 1012 may be collateralized by other liquid or illiquid assets, such as stocks, mutual funds, shares of proxy assets, other types of ownership interest or rights, or some combination thereof.

In any of the foregoing embodiments, the value of the resource pool 1026 may be held substantially constant, with distributions made of any earnings on the underlying collateral, or the resource pool may be adjusted. When adjusted, the value of the resource pool may be adjusted as a function of a triggering event. The triggering event may include one or more of a plurality of events, such as a termination of a predetermined period of time, adding or deleting an index from a set of asset indices, a value variation in said set of indices (or an index therein), a change in a set of one or more economic indicators, a change in a level of risk reward, a change in the value of one or more of the underlying assets, a change in the prime lending rate, or a change in the attractiveness of proxy asset shares (e.g., up, down or both). These are, of course, merely examples and any of a number of economic events, or events having an economic impact, that may serve as a triggering event. Such triggering events may be monitored by a proxy asset computer system 1010 and the proxy asset resource pool 1026 may be automatically adjusted in response to such events by the proxy asset computer system. In other embodiments, the resource pool 1026 may be manually adjusted.

Additionally, in any of the preceding embodiments, the offering of proxy asset shares may be terminated as a function of a termination triggering event. The termination triggering event may be one or more of a variety of events, including predetermined events or events not previously determined. For example, such termination triggering events may include a termination of a predetermined period of time, a value variation in the set of asset indices 1042 (or an index therein), a change in rate of return of said proxy asset shares 1014 and 1016, a change in the level of risk reward to investors, a change in the value of the resource pool 1026, a change in one or more of the underlying assets, a change in the prime lending rate, or a change in the attractiveness of proxy asset shares (e.g., up, down, or both). When shares cease to be offered, they may be purchased from the owners of the shares with payouts, or distributions made according the then market value of the shares. In other instances, payouts or distributions may be transferred to a different investment vehicle in response to aforementioned types of triggering events, or some other triggering event. The termination events may be automatically monitored and the offering of shares automatically terminated by the proxy asset computer system 1010, or may be manually accomplished. In such cases, the payouts or distributions may be automatically or manually accomplished.

The proxy assets shares may be publicly or privately offered for sale. The shares may be purchased and sold in packages (as in pairs, for example) or independently (e.g., as in buying only down shares, for example). For example, the down proxy asset shares 1014 and the up proxy asset shares 1016 may be offered via the same channels as publicly available stocks, funds, bonds, and so on. Proxy asset shares may be offered on any of a variety of public or private, foreign or domestic exchanges. For example, shares of proxy assets could be offered on the NYSE, American Stock Exchange, or any of a number of exchanges, as will be appreciated by those skilled in the art. The proxy asset shares (e.g., down shares 1014 and up shares 1016) may be offered by any number of financial institutions 1028, such as banks, investment firms, brokers, and the like. Several entities may play different roles in creating a set of proxy assets, defining the functions by which the value of proxy asset shares are determined, managing the resource pool, brokering proxy asset shares, and so forth.

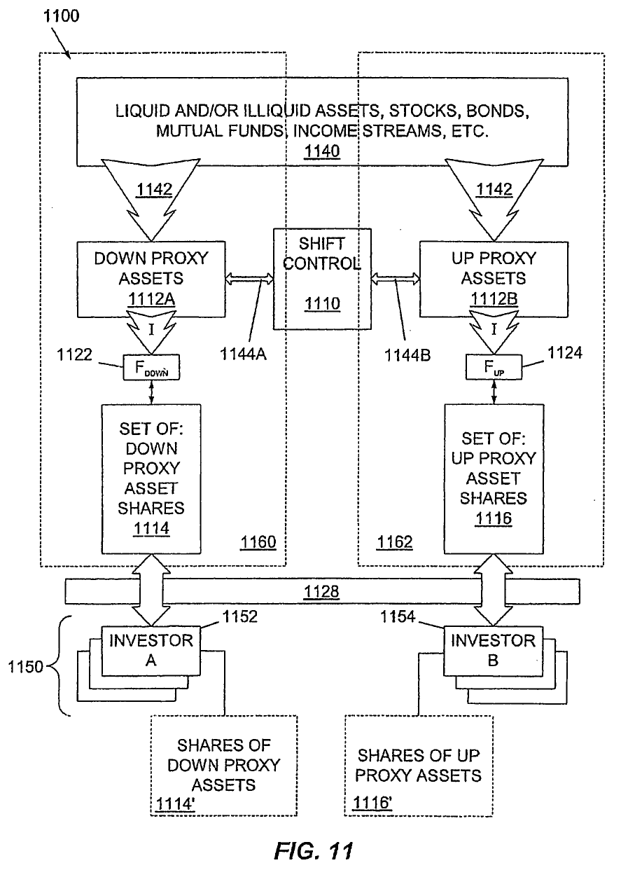

In other embodiments, such as the embodiment of FIG. 11, a proxy asset system 1100 may define a set of proxy assets comprised of two or more subsets (or pools) of proxy assets, e.g., down proxy assets 1112A and up proxy assets 1112B. Each set of proxy assets may be related to a common set of underlying assets, such as the one or more liquid and/or illiquid assets described above. In such a case, as described above, a proxy asset index I is based on an asset index 1142 (similar to asset index 1042 above) that reflects a value of the underlying assets 1140. Also, a set of down proxy asset shares 1114 represent claims on the pool of down proxy assets 1112A and a set of up proxy shares 1116 represent claims on the pool of up proxy asset shares 1112B. As described with respect to FIG. 10, the value of the down proxy asset shares is determined as a function (e.g., function F.sub.down 1122) of the proxy asset index I and the value of the up proxy asset shares is determined as a function (e.g., function F.sub.up 1124) of the proxy asset index I. Similar to the embodiment of FIG. 10, the change in value of proxy asset shares is accomplished via the shifting of proxy assets between the pool of down proxy assets 1112A and the pool of up proxy assets 1112B, as indicated by arrow 1144.

However, in the embodiment of FIG. 11, a shift control 1110 is inserted between these two pools of proxy assets (i.e., 1112A and 1112B), which may take the form of a module of computer system 1100 (which is otherwise similar to computer system 1000). In such a case, at least one financial institution acting as or controlling the shift control 1110 enters into separate relationships (e.g., contracts) with the investors of down proxy shares and the investors of up proxy asset shares. For example, investors 1152 in down proxy asset shares 1114′ may enter into a relationship with the financial institution regarding the operations of down proxy asset shares. This relationship may be, for example, conceptualized as pertaining to elements within dashed line box 1160, wherein the relationship includes obligations pertaining to the transfer of proxy assets to and from the set of down proxy assets 1112A, depicted by double arrow 1144A. However, there are no per se obligations of the financial institution regarding transfers of proxy assets to pools of proxy assets not covered by the contract between the investor 1152 and the financial institution. Therefore, transfers of proxy assets to and from the set of up proxy assets 1112B would not be covered by the relationship between investor A 1152 and the financial institution. Investors in up proxy assets shares 1116′ have a corresponding relationship (e.g., contract) with the financial institution conceptualized as pertaining to elements within dashed line box 1162, wherein the relationship includes obligations pertaining to the transfer of proxy assets to and from the set of up proxy assets 1112B, depicted by double arrow 1144B.

In the case of FIG. 11, the financial institution may or may not also be the broker 1128, or may be one of many brokers involved in offering proxy asset shares. In various embodiments, the shift control 1110 may be used to otherwise manipulate the values of the up and down shares, by inhibiting the natural shifting of proxy assets as a function of the proxy asset index (or set of asset indices). The proxy asset shares of FIG. 11 may be offered in any of the manners previously described (e.g., on public or private foreign or domestic exchanges). Each set of proxy assets shares (e.g., down shares 1114 and up shares 1116) may be treated as being relatively independent. Down shares and up shares may be purchased, sold, and/or valued in different manners and/or by different entities. Also, shares related to different sets of proxy assets (e.g., up shares and down shares) may be offered at the same time, or at different times. Shares for a given set of proxy assets (e.g., down shares 1014) may be issued and redeemed at different times (e.g., incrementally, periodically, etc.). Whether offered at the same time or offered at different times, generally, any proxy asset shares may be offered as a function of one or more conditions (e.g., the value of the resource pool reaching a certain threshold, the value of the proxy asset index reaching a certain threshold value, the value of the asset indices reaching a certain value, and so on).

In any of the foregoing embodiments, it may be desirable to raise money for one pool of proxy assets, rather than both sets. This may be accomplished at initial public offering, or some time thereafter. For example, if down proxy asset shares cease to become an attractive investment due to, for example, an imbalance in the relationship between the down shares and the up shares, the relationship may be rebalanced at any point in time. Rebalancing may take the form of modifying the conditions under which assets get shifted between the pool of down proxy assets 1012A and down proxy assets 1012B. This may include, modifying the functions F.sub.down 1022, and/or F.sub.up 1124, the index I, or weighting the index I, or weighting the asset indices upon which the index I is based. The rebalancing may also include redeeming proxy asset shares, modify the underlying resources or modifying that which is used to collaterlize the proxy assets. The rebalancing may also include issuing or cashing out proxy asset shares from the pool of down proxy assets 1012A, the pool of up proxy assets 1012B, or both.

In some embodiments, again to keep the proxy asset shares as competitive investments, the issuer of the proxy asset shares may, from time to time, reset the settlement price for the proxy asset shares. For example, this may be done periodically or in response to economic factors that undesirably alter the attractiveness of the proxy asset shares as an investment. This resetting may be done to redistribute the proxy assets, and consequently rebalance the resource pool 1026 between the down account 1018 and the up account 1020. It may also be done to alter the account functions 1022 and 1024. At the discretion of the issuer, the point in time when the resetting is accomplished may serve as the point in time (e.g., a new start or initial offering time) from which other account activity is related, such as determining subsequent changes in the proxy asset index or applying the relevant account formulas (e.g., functions 1022 and 1024).

Various embodiments may also include mechanisms for adjusting the offering of proxy asset shares as the investment vehicle nears stock out or reaches some other thresholds, for example, in terms of proxy asset index movement. In such a case, there may be an adjustment that keeps the price of a proxy asset share (e.g., up shares or down shares) going forward competitive in terms of yield. As an example, primary mechanisms involve either dividending out principal or rolling over the principal into a new offering. The principle exists in the resource pool generally, but may be more specifically allocated to the down account 1018 or the up account 1020; for example, and attributed to the value of the corresponding proxy asset shares. As an example, a dividend scenario would be one where the proxy asset index has moved significantly in one direction and the issuer then takes the resource pool and either just pays some of it out to the side winning (i.e., the up shares or down shares) at that point to rebalance to resource pool, takes the resource pool and uses it to buy the actual security (i.e., underlying asset) that proxy asset represents and then dividends that out proportionally. As an example, if the asset index was representative of the S&P 500, then proceeds from the resource pool 1026 would be used to by SPDRs, i.e., the S&P 500 exchange traded security, or if it were representative of an individual corporate stock, then proceeds from the resource would be used to buy shares of that corporation's stock. In another example, the proceeds from resource pool may be rolled over into proportionate shares of a similar new issue of proxy asset shares at that point with a new share (or reset) price. Otherwise, the proceeds may be rolled into other types of investment vehicles. For example, it may be predetermined that proceeds, if any, will be used to by low risk securities (e.g., Treasuries), high risk securities (e.g., high risk mutual fund), or investments having risk-reward features similar to those of the proxy asset shares. As will be appreciated by those skilled in the art, there is a wide variety of manners in which such proceeds may be disposed.

In the embodiments of FIG. 10 and FIG. 11 (or in other embodiments), the function of establishing the set of proxy assets 1012 (including the up and down proxy assets), the proxy assets index, the up and down proxy asset shares, the resource pool (including the up and down accounts) may be accomplished and managed by the proxy asset management computer system 1010. Computer system 1010 may be a single computer system or a network of distributed computer systems cooperating. Indices 1042 may serve as an input to system 1010 and the down proxy asset shares and up proxy asset shares may be managed and offered via system 1010. That is, a variety of functions may be accomplished or supported by system 1010, including issuance, redemption, buying, selling, resource pool and account management (including rebalancing), brokering of proxy asset shares, and the distribution of dividends and payouts related to the up and down proxy asset shares. System 1010 may include interfaces to third party providers of information or financial institutions, including brokers, fund managers, portfolio managers, market makers, exchanges and so forth.

As an automated system, various embodiments may allow for or facilitate on-line (e.g., Internet or Web based) trading of proxy asset shares, which may be public or private, as part of a trading system. Trading may be tightly controlled and only via privileged access (e.g., through a secure Web site). Or, trading may be available to the public generally via a public trading Web site interface, or it may be available to the public through the interface of a third party financial institution (e.g., Fidelity Investments at www.fidelity.com). In this regard, interfaces may be provided offering various types of information relevant to the proxy asset system, such as information pertaining to the proxy assets, proxy asset index, proxy asset shares, the underlying asset indices, the formulas for adjusting the value of shares as a function of the proxy asset index, and the characteristics of shifting proxy assets between the pools of up and down proxy assets. For example, information available through a computer interface (e.g., Web site) may include the name of the proxy asset (or proxy asset shares), date of issuance of the proxy asset shares, date interest was/is scheduled to be paid, approximate current yield, provisions in the particular issue for repricing, special dividends, rollovers, provision/expectation of stock out, historical performance, and projected performance. In certain embodiments, functionality (e.g., in the form of an applet) may be provided at the trading system Web site that investors could use to help them price the security or compare proxy asset shares to other investment vehicles.

Also, with respect to any of the foregoing embodiments, or other embodiments not disclosed herein, shares related to different proxy assets may be purchased, sold, and/or valued in different manners and/or by different entities. Also, shares related to different sets of proxy assets (e.g., up shares and down shares) may be offered at the same time, or at different times. Shares for a given set of proxy assets (e.g., down shares 1014) may be issued and redeemed at different times (e.g., incrementally, periodically, etc.). Whether offered at the same time or offered at different times, generally, any proxy asset shares may be offered as a function of one or more conditions (e.g., the value of the resource pool reaching a certain threshold, the value of the proxy asset index reaching a certain threshold value, the value of the asset indices reaching a certain value, and so on).

Additionally, in any of the foregoing embodiments, or substantially similar embodiments, non-proxy assets (e.g., shares in a public or privately offered, foreign or domestic corporate stock or mutual funds) may be pooled or combined with proxy assets to form a hybrid pool of assets and proxy asset shares may represent claims on the hybrid pool of assets. In such a case, the non-proxy asset shares may be altered after initial offering, i.e., shares of non-proxy assets may be bought sold in and out of the hybrid pool of assets.

Although the invention has been described in detail for the purpose of illustration, it is to be understood that such detail is solely for that purpose and that variations can be made therein by those skilled in the art without departing from the spirit and scope of the invention. Indeed, some variations may need to be made to satisfy requirements of regulators, tax authorities, existing exchanges, brokers and underwriters, requirements that may vary through time and across countries. That is, the invention may be embodied in other specific forms without departing from the spirit or central characteristics thereof. The present embodiments are therefore to be considered in all respects as illustrative and not restrictive, the scope of the invention being indicated by appending claims rather than by the foregoing description, and all changes that come within the meaning and range of equivalency of the claims are therefore intended to be embraced therein.

It should be appreciated, in this example the rules for earnings allocation were a function of the entitlement amount, but the rules for interest allocation could be different in other embodiments. There is no inherent limitations in such rules, the determination of which are largely a function of the marketability of products implementing the present system and method.

TABLE 1
DATABASE STRUCTURE

Format:
Records
Fields
Shareholder Information:
Customer or Client I.D. Number:
Name or firm:
Address:
Proxy Asset or Bundle ID Numbers*:
Current Numbers of Shares or Bundles Owned in Each*:
Transaction ID Numbers*:
Transaction Information:
Transaction ID Number:
Proxy Asset or Bundle ID Number:
Buyer ID Number:
Seller ID Number:
Exchange, Issuance or Redemption:
Date and Time:
Number of Shares or Bundles:
Price per Share or Bundle:
Complete Set ID Number:
Buy and Sell Orders:
Order Number:
Customer ID Number:
Buy Order or Sell Order:
Proxy Asset ID Number or Bundle ID Number:
If Market Order: Numbers of Shares or Bundles
If Limit Order: Price and Numbers of Shares or Bundles
If Stop Order: Price and Numbers of Shares or Bundles
Order Date and Time*:
Order Expiration Date and Time: e.g. fill order until
1:00 pm Jan. 5, 1998
Pooled Cash Account Information:
Total Investable Assets Held for Cash Accounts (in Bank) (Vₜ):
Total Number of Shares Outstanding in Entire System (Sₜ):
Average Cash Account Balance per Share in System (Vₜ/Sₜ):
Complete Sets:
Set Number:
Proxy Asset or Bundle ID Numbers in Set*:
Index Information:
Index ID Number:
Update Frequency: e.g. quarterly
Date of Last Update:
Market Description: e.g. single family homes in Metro Los Angeles
Price or Income Index: e.g. price
Date*: e.g. First Quarter 1980
Index Level*: e.g. 100.00
Cash Account Formula:
Cash Account Formula ID Number:
Proxy Asset Type: Swap, Up or Down, etc.:
Cash Account Formula: e.g.,
a) for up Cash Account = index (index ID number)
b) for down Cash Account 2 × Vₜ/Sₜ, - index (index ID number)
c) for swap Cash Account Vₜ/Sₜ, + 2 × (A Index − B Index)
(index ID numbers)
Dividend Payout Formula:
Dividend Payout Formula ID Number:
Proxy Asset Type: Swap, Up or Down, etc.:
Dividend Payout Dates*:
Dividend Payout Formula: e.g.,
dividend paid per share = 0.02 × (Cash Account balance)
Proxy Asset Balance Change Information:
Proxy Asset Cash Balance Change Formula ID:
Proxy Asset ID Number:
Index ID Number*:
Cash Account Formula ID Number:
Cash-Balance Change Frequency: e.g. quarterly
Next Cash Balance Change Date:
Historical Cash Balance Changes:
Historical Cash Balance Change ID Number
Historical Cash Balance Change Date*:
Historical Cash Balance Before Change Amount*:
Historical Cash Balance Change Amount*:
Historical Cash Balance After Change Amount*:
Proxy Asset Definition:
Proxy Asset ID Number:
Proxy Asset Type: Swap, Up or Down:
Initial Cash per Share: e.g. $100.00
Base Date: e.g. Jan. 10, 1998
Current Number of Shares Outstanding: e.g. 500,000
Current Cash Account Balance per share: e.g. $100
Dividend Frequency:
Next Dividend Due: e.g. Jan. 10, 1998
Cash Account Formula ID Number:
Dividend Payout Formula ID Number:
Next Cash Balance Change Due: e.g. Jan. 10, 1998
Cash Account Number:
Next Interest Deposit Due:
Issuance ID*:
Redemption ID*:
Proxy Asset Bundle Definition:
Proxy Asset Bundle ID:
Proxy Asset ID Numbers*:
Number of Shares of Each Proxy Asset in Bundle*:
Issuance History:
Proxy Asset or Bundle ID Number:
Complete Set ID Number:
Issuance ID Number:
Issuance Date:
Number of Shares:
Issuance Amount per Share:
Redemption History:
Proxy Asset or Bundle ID Number:
Complete Set ID Number:
Redemption ID Number:
Redemption Date:
Number of Shares:
Redemption Amount per Share:
*May be a multiple field

TABLE 2
FUNCTIONS OF PROXY ASSET DATA PROCESSOR

1. Functions Ordered by System Proprietor
Add Index Data (run manually)

Load new Index into Index Record Database
Fill in other Fields of Index Record

Update Interest Payment (run daily)
For Each Proxy Asset:

Is Interest Deposit Due Today?
If Yes:

Adjust Current Cash Balance with Interest Payment
Fill in Next Interest Deposit Due

Pay Dividends (run daily)
For Each Proxy Asset:

Interest Deposit Run for Today?
If Yes:

Dividend Payment Due Today?

If Yes:

Use Dividend Payout Formula to Calculate
Dividend
Pay Dividend, adjust Current Cash Account
Balance
Fill in Next Dividend Payment Due

Update Indices (run daily)
For each Index
Date for an Index Update?

If Yes:

Receive Index Update Into Index Record

Update Cash Account Balances Using Cash Account Formulas (run
daily)

Index, Interest and Dividend Update Performed Already for
Today?

If Yes
For each Proxy Asset:

Look up Cash Balance Change Formula and Necessary
Indices
Calculate Cash Account Balances Change

Is Transfer Between Accounts due today?

If Yes:

Make Transfers Among Cash Accounts according
to Cash Account Formula

Define New Swap Proxy Asset (run manually)

Select the Two Indices to be used, Rescale to 100 on Base Date
Select Formula Type
Fill in Base Date and Initial Cash Per Share
Fill in Cash Account Formula
Fill in Dividend Payout Formula
Make List of all Complete Sets

Define New, Up/Down Proxy Asset Pair (run manually)

Select the Index to be Used, Rescale to 100 on Base Date
Select Formula Type
For both Up and Down Proxy Asset:
Fill in Base Date and Initial Cash Per Share (same for both)
Fill in Cash Account Formula
Fill in Dividend Payout Formula
Make List of All Complete Sets

2. Functions Ordered by Brokers
Process Buy Or Sell Orders (run when an order comes in)
(If for a Bundle, treat each Proxy Asset in Bundle as shown below)
Receive Transaction Request and Enter into Database
Display Order on Screen with Other Unfilled Orders
Display Historical Values of Indices
Display Cash Account Balances
Search for combinations of non-expired Buy and Sell Orders of
same Proxy Asset
Identify Matches in Limit Orders and Numbers of Shares

If found, Execute Orders through Exchange of Existing Shares
If None Found,
Combine Order with other Orders of same type (e.g. Buys for
same Proxy Asset)
If a Bid for Proxy Asset

Search for Complete Set Among Bids
If Total Bid Prices in Set ≧ Total Cash Account Balances

Then:
Issue New Shares
Create Transaction Records
Create Complete Set Record
Fill in Issuance Records
Create Investor Records
Fill in Historical Cash Balance Changes Record
Update Number of Shares and Current Cash Balance in
Proxy Asset Record
If an Offer to Sell a Proxy Asset
Search for Complete Sets among Offers
If Total Offer Prices in Set ≦ Total Cash Account Balances
Then:

Redeem Existing Shares
Create Transaction Records
Create Complete Set Record
Fill in Redemption Records
Update Investor Records
Fill Historical Cash Balance Changes Record
Update Number of Shares and Current Cash Balance in

Proxy Asset Record

Provide Information for Electronic Trading System

Order Processing and Confirmation
Provide Information for Book Window for Trading Screen

Provide Responses to Requests for Alerts - e.g., alert traders
when a specified price level has been reached either by a trade in
subject proxy asset or by trades in other proxy assets within
the same complete set
3. Functions ordered by Investors (Informational Web Site):
View Indices
View Outstanding Limit Orders (Book Window)
View. Composition of Bundles View Proxy Asset

Base Date
Indices used
Cash Account Balance per Share
Starting Cash Account Balance per Share
Cash Account Balance Change History
Dividend Payment History
Cash Account Formula
Dividend Payout Formula

What is claimed is:

1. A method comprising:
(A) establishing an up-holding trust that increases in value as a function of a positive move in at least one index, price or economic variable and establishing a down-holding trust that increases in value as a function of a negative move in the at least one index, price or economic variable.
(B) entering a first set of contracts between the up-holding trust and the down-holding trust that provide for a transfer or reallocation of assets on a specified settlement date or dates to reflect a positive or a negative move in the at least one index, price or economic variable;
(C) entering a second contract between the down-holding trust and the up-holding trust that provide for a periodic transfer between the trusts of earnings realized on each trust's assets based upon positive or negative moves in at least one index, price or economic variable; this contract is optional and may not be presented in each transaction;
(D) defining an up-tradable trust related to the up-holding trust, the up-tradable trust issuing up-tradable claims backed by substantially all or some portion of the securitized claims issued by the up-holding trust; and
(E) defining a down-tradable trust representing the down-holding trust, the down-tradable trust issuing down-tradable claims backed by substantially all or some portion of the securitized claims issued by the down-holding trust.

2. A method according to claim 1, further comprising managing the assets of the up-holding trust or of the down-holding trust.

3. A method according to claim 1, further comprising forming the up-holding trust or the down-holding trust by a company affiliated with the up-holding trust or the down-holding trust.

4. A method according to claim 1, further comprising the up-holding trust issuing one or more limited-life shares and the down-holding trust issuing one or more limited-life shares, wherein the limited life shares are outstanding for a predetermined term or until a termination event occurs.

5. A method according to claim 1, further comprising the up-holding trust and the down-holding trust investing in short-term financial instruments.

6. A method according to claim 5; wherein investing in short-term financial instruments includes investing in highly-rated financial instruments.

7. A method according to claim 5, wherein investing in short-term financial instruments includes investing in United States treasury obligations

8. A method according to claim 1, further comprising determining an underlying value of the up-holding trust and the down-holding trust.

9. A method according to claim 8, further comprising shifting interested between the up-holding trust and the down-holding rust.

10. A method according to claim 1, further comprising the up-holding trust entering into a swap agreement with the down-holding trust for allocating available earnings between the up-holding trust and down-holding trust, wherein available earnings include an amount equal to the interest component on a trust asset minus trust fees and expenses.

11. A method according to claim 1, further comprising the down-holding trust entering into a swap agreement with the up-holding trust for allocating available earnings between the down-holding trust and up-holding trust, wherein available earnings include an amount equal to the interest component on a trust asset minus trust fees and expenses.

12. A method according to claim 10, further comprising calculating the available earnings for the up-holding trust.

13. A method according to claim 11, further comprising calculating the available earnings for the down-holding trust.

14. A method according to claim 1, further comprising the up-holding trust entering into one or more forward contracts with the down-holding trust, wherein an asset amount is allocated between the up-holding trust and the down-holding trust.

15. A method according to claim 1, further comprising the down-holding trust entering into one or more forward contracts with the up-holding trust, wherein an asset amount is allocated between the down-holding trust and the up-holding trust.

16. A method according to claim 1, further comprising issuing additional shares of the up-holding trust or down-holding trust subsequent to an initial issuance of original shares of the up-holding trust or down-holding trust.

17. A method according to claim 1, further comprising redeeming holding shares of the up-holding trust or down-holding trust.

18. A method according to claim 17, wherein redeeming holding shares includes redeeming pairs of shares of the up-holding trust or down-holding trust or both.

19. A method according to claim 17, wherein redeeming holding shares includes redeeming a proportionate amount of shares of the up-holding trust and down-holding trust.

20. A method according to claim 4, further comprising each of the up-holding and down-holding trusts depositing the limited-life certificates into one or more tradeable trusts.

21. A method according to claim 1, wherein establishing each of the up-holding trust and the down-holding trust includes placing a desired asset into the respective trust.

22. A method comprising:
(A) establishing a plurality of up-trusts that increase in value as a function of a positive move in at least one index, price or economic variable;
(B) establishing a plurality of down-trusts that increases in value as a function of a negative move in the at least one index, price or economic variable;
(C) entering a set of contracts between one or more of the plurality of up-trusts and one or more of the plurality of down-trusts, the set of contracts effecting a shift in value between the up and down trusts in response to a change in at least one index, price or economic variable; and
(D) offering securitized claims, as investments, against one or more of the plurality of up-trusts and/or the plurality of down-trusts.

23. A method according to claim 22, further comprising managing the assets of the plurality of up-trusts or of the plurality of down-trust.

24. A method according to claim 22, further comprising forming the plurality of up-trusts or the plurality of down-trusts by a company affiliated with at least one of the plurality of up-trusts and the plurality of down-trusts.

25. A method according to claim 22, further comprising the plurality of up-holding trusts issuing one or more limited-life shares and the plurality of down-holding trusts issuing one or more limited-life shares, wherein the limited life shares are outstanding for a predetermined term or until a termination event occurs.

26. A method according to claim 22, further comprising the plurality of up-holding trusts and the plurality of down-holding trusts investing in short-term financial instruments.

27. A method according to claim 26, wherein investing in short-term financial instruments includes investing in highly-rated financial instruments.

28. A method according to claim 26, wherein investing in short-term financial instruments includes investing in United States treasury obligations

29. A method according to claim 22, further comprising determining an underlying value of the plurality of up-holding trusts and the plurality of down-holding trusts.

30. A method according to claim 29, further comprising shifting interested between the plurality of up-holding trusts and the plurality of down-holding trusts.

31. A method according to claim 22, further comprising the plurality of up-holding trusts entering into a swap agreement with the plurality of down-holding trusts for allocating available earnings between the plurality of up-holding trusts and the plurality of down-holding trusts, wherein available earnings include an amount equal to the interest component on a trust asset minus trust fees and expenses.

32. A method according to claim 22, further comprising the plurality of down-holding trusts entering into a swap agreement with the plurality of up-holding trusts for allocating available earnings between the plurality of down-holding trusts and the plurality of up-holding trusts, wherein available earnings include an amount equal to the interest component on a trust asset minus trust fees and expenses.

33. A method according to claim 32, further comprising calculating the available earnings for the plurality of up-holding trusts.

34. A method according to claim 32, further comprising calculating the available earnings for the plurality of down-holding trusts.

35. A method according to claim 33, further comprising the plurality of up-holding trusts entering into one or more forward contracts with the plurality of down-holding trusts, wherein an asset amount is allocated between the plurality up-holding trusts and the plurality of down-holding trusts.

36. A method according to claim 34, further comprising the plurality of down-holding trusts entering into one or more forward contracts with the plurality of up-holding trusts, wherein an asset amount is allocated between the plurality of down-holding trusts and the plurality of up-holding trusts.

37. A method according to claim 22, further comprising issuing additional shares of the plurality of up-holding trusts or plurality of down-holding trusts subsequent to an initial issuance of original shares of the plurality of up-holding trusts or plurality of down-holding trusts.

38. A method according to claim 22, further comprising redeeming holding shares of the plurality of up-holding trusts or plurality of down-holding trusts.

39. A method according to claim 38, wherein redeeming holding shares includes redeeming pairs of shares of the plurality of up-holding trusts or plurality of down-holdings trust or both.

40. A method according to claim 38, wherein redeeming holding shares includes redeeming a proportionate amount of shares of the plurality of up-holding trusts and plurality of down-holding trusts.

41. A method according to claim 25, further comprising each of the plurality of up-holding trusts and plurality of down-holding trusts depositing the limited-life certificates into one or more tradeable trusts.

42. A method according to claim 22, wherein establishing each of the plurality of up-holding trusts and the plurality of down-holding trusts includes placing a desired asset into the respective trust.
